(19) United States
(12) Patent Application Publication
(10) Pub. No.: US 2007/0082155 A1
(43) Pub. Date: Apr. 12, 2007

(54) Polymer films and methods of producing and using such films

(76) Inventors: Richard Alan Rehkugler, Fairport, NY (US); Richard John Schoonerman, New York, NY (US); Jay Kin Ming Keung, Humble, TX (US)

Correspondence Address: ExxonMobil Chemical Company;Law Technology, P.O. Box 2149, Baytown, TX, 77522-2149, US

(21) Appl. No.: 11/521,657

(22) Filed: Sep. 15, 2006

Related U.S. Application Data
(63) Continuation-in-part of application No. 11/248,838, filed on Oct. 12, 2005.

(51) Int. Cl. B32B 27/08

(52) U.S. Cl. 428/35.7

(57) ABSTRACT

Multi-layer films particularly suited for packaging applications, including a core layer, a tie layer made from at least 10 wt % of a first polymer and a service layer, wherein the tie layer is a sealable layer and may provide a hermetic seal when sealed to itself. The films of this invention may be suitable for use in preparing hermetically sealed packages. Optionally, the multi-layer film may have a skin layer and/or a second skin layer. Embodiments may have the advantage of improved seal strength, hermeticity, hot tack, reduced-temperature sealability, and improved packaging machine operating speed.

### CROSS-REFERENCE TO RELATED APPLICATIONS

This application is a continuation-in-part and claims benefit of and priority to U.S. application Ser. No. 11/248,838 filed Oct. 12, 2005. The specification of the aforementioned application is incorporated herein by reference.

### FIELD OF THE INVENTION

This invention relates generally to composite, heat-sealable, multi-layer polymer films and more specifically to such films and/or film-based compositions comprising such films, methods of producing such compositions, and products comprising such films. More specifically, this invention relates to multi-layer films with improved hermetic and sealing properties, as compared to prior art films, that may be useful as a packaging film. The films may be useful alone or combined, such as by lamination, with other polymer films or materials to form a useful composition.

### BACKGROUND OF THE INVENTION

Polypropylene-based multi-layer films (“OPP” films) are widely used in packaging applications, such as pouches for dry food mixes, pet foods, snack foods, and seeds. OPP Films means oriented polymer films including at least 50 wt % of propylene. Such multi-layer films must have the ability to form reliable seals at relatively low temperatures, particularly with respect to hermeticity and seal strength. In some instances, the film must do so in the presence of contamination in the seal region from the contents of the pouches.

Polymer film packaging applications requiring premium hermeticity and seal strength in the seal area typically rely upon a layer of polyethylene or a layer comprising polyethylene in the multilayer film, such as in the tie layer or skin layer, to achieve such performance. A hermetic sealing, high seal strength oriented polypropylene film is not presently available. Polyethylene layers have been required to obtain high-performance seals. The polyethylene-layer-containing films may be laminated to other films to obtain a more comprehensive performing composite polymer film. For example, a film containing polyethylene within a tie layer may be laminated to a barrier film outside web, to obtain a composite film that provides hermetic seals, seal strengths in excess of 2000 g/in, and good barrier properties.

U.S. Pat. No. 6,624,247 B1 to Kume et al. (Sumitomo Chemical Company, Ltd.) discloses a polypropylene-based film of a resin composition (C) comprising: 40 to 95 weight percent of a propylene-based copolymer (A) and 5 to 60 weight percent of a polypropylene-ethylene and/or alpha-olefin block copolymer (B) having a xylene soluble component (“CXS”) of 5.0 weight percent or more, wherein the CXS has a content of ethylene and/or the alpha-olefin of 14 to 35 molar percent and wherein the heat-seal temperature of the film of the composition (C) is lower by 3° C. or more than those of respective films of the compositions (A) or (B).

U.S. Pat. No. 6,641,913 B1 to Hanyu et al. (Fina Technology, Inc.) discloses a multi-layer polyolefin film of the type suitable for packaging applications in which heat seals are formed. The multi-layer film comprises a substrate layer formed of a crystalline thermoplastic polymer having an interface surface. A heat-sealable surface layer is bonded to the interface surface of the substrate layer and is formed of a syndiotactic propylene polymer effective to produce a heat seal with itself at a sealing temperature of less than 110° C. The multi-layer film may be biaxially-oriented. In the production of the multi-layer film, a crystalline thermoplastic polymer is extruded and formed into a substrate layer film. A second polymer comprising a syndiotactic propylene polymer that is effective to form a heat-sealable surface layer is extruded separately to form a surface layer that is thereafter bonded to the interface of the substrate layer at a temperature within the range of 150° C. to 260° C.

U.S. Pat. No. 6,534,137 B1 to Vadhar (Cryovac, Inc.) discloses a two-component laminated multi-layer film suitable for use in packaging articles, such as pet food, comprising a first component and a non-heat-shrinkable second component. The first component comprises an outer first film layer, an optional second film layer, and an optional third film layer. The first and third film layers comprise ethylene/alpha-olefin copolymer, while the second film layer is a modified ethylene copolymer. The second component comprises an outer fourth layer, an oxygen barrier fifth layer, sixth and seventh layers that serve as tie layers and are positioned on either side of the barrier layer. The multi-layer film is heat sealable to itself and another film.

U.S. Pat. No. 6,794,021 B2 to Bader (ExxonMobil Oil Corporation) discloses a thermoplastic multi-layer film for forming hermetic seals on packages comprising layer A comprising polyethylene, layer B comprising polypropylene, layer C comprising a copolymer, and an adhesion promoting coating applied to layer C and a method of improving multi-layer films whereby hermetic seals can be simply and efficiently formed and whereby excellent seat characteristics are achieved.

U.S. Pat. No. 5,888,648 X6 to Donovan et al. (Mobil Oil Corporation) discloses a multi-layer film that has an improved composite structure for providing hermetic seals to packages manufactured in a high speed packaging apparatus. The structure of the multi-layer film includes a main substrate and a sealant layer. The sealant layer, in turn, includes an intermediate layer that has the primary function of compliance during sealing and a sealing layer that has the primary function of providing adhesivity to the completed seal.

U.S. Pat. No. 6,326,068 B1 to Kong et al. (Mobil Oil Corporation) discloses a multi-layer film that has an improved composite structure for providing hermetic seals to packages manufactured in a high speed packaging apparatus. The structure of the multi-layer film includes layers A/B/C/D. Skin layer A is formed from polypropylene copolymer with melt flow rate greater than one or linear high density polyethylene with melt index greater than one. Core layer B is formed from polypropylene. Intermediate layer C has the primary function of compliance during sealing, and sealing layer D has the primary function of providing adhesivity to the completed seal. The sealing layer D includes an anti-blocking agent comprising non-distortable organic polymer particles having an average particle size greater than 6 microns.

Related U.S. application Ser. No. 10/079,662 to Bader, filed on Feb. 20, 2002, which is a CIP of application Ser. No. 09/791,325 (now abandoned) discloses a core layer B that comprises a softening additive blended in a core layer to improve the hermeticity of a sealed package. The softening additive enhances compliance of the core layer with the sealable layer while the seal area is heated under pressure within the crimp jaws during sealing operations. The invention of the '662 application functions during sealing operations to effect a more hermetic seal. The term “compliance” as used in the '662 application is related to non-elastic, deformation or conformance within the sealing jaws during sealing operations due to the improved flowability of the core during heated sealing operation and does not refer to post-sealing seal strength and post-sealing seal performance. It is possible to improve hermeticity as per the '662 application without necessarily, substantially improving minimum seal strength.

U.S. Pat. No. 6,927,258 B2 and U.S. application Ser. No. 11/123,904 to Datta, et al. (ExxonMobil Chemical Company) disclose improved thermoplastic polymer blend compositions comprising an isotactic polypropylene component and an alpha-olefin and propylene copolymer component, the copolymer comprising crystallizable alpha-olefin sequences. In a preferred embodiment, improved thermoplastic polymer blends are provided comprising from about 35% to about 85% isotactic polypropylene and from about 30% to about 70% of an ethylene and propylene copolymer, wherein the copolymer comprises isotactically crystallizable propylene sequences and is predominately propylene. The resulting blends manifest unexpected compatibility characteristics, increased tensile strength, and improved process characteristics, e.g., a single melting point.

Other U.S. Patent applications that are related to improvements in film seal technology may include U.S. Pat. No. 5,527,608, granted Jun. 18, 1996; U.S. Pat. No. 6,326,068, granted Dec. 4, 2001; and U.S. Pat. No. 6,794,201, granted Sep. 21, 2004. However, each of the aforementioned patents and their corresponding inventions fail to teach or describe the benefits of this invention, including the substantial improvements in hermeticity and seal strength, among other benefits. None of the films described above combine desired improvements in seal strength, hermeticity, hot tack and sufficiently reduced seal temperatures for some of today's most challenging flexible packaging operations. Opportunities exist for polymer films to replace other packaging substrates, such as paper and foil, in many temperature-sensitive packaging operations, such as with ice cream bars, chocolate bars, and dry-particulate foods. Opportunities also exist to replace polymer films that rely upon polyethylene or ethylene-containing polymers within its layers to achieve acceptable levels of hermeticity and seal strength, with polymer films that utilize polypropylene in the sealing function of the films and packaging products made therefrom. The present invention meets these and other needs.

### SUMMARY OF THE INVENTION

The present invention generally relates to multi-layer films comprising a core layer and a tie layer, the tie layer having at least 10 wt % of a first polymer having a density in the range of 0.850 g/cm³ to 0.920 g/cm³, a Differential Scanning Calorimetry (DSC) melting point in the range of 40° C. to 160° C., and a melt flow rate (MFR) in the range of 2 dg/min. to 100 dg/min. Preferably, the core layer is substantially free of the first polymer.

In another embodiment, the invention generally relates to multi-layer films comprising a core layer, a service layer, and a tie layer, the tie layer having at least 10 wt % of a first polymer comprising from about 75 wt % to about 96 wt % propylene and from about 4 wt % to about 25 wt % ethylene, the first polymer having a density in the range of 0.850 g/cm³ to about 0.900 g/cm³, and optionally a skin layer with the tie layer intermediate to the core layer and the skin layer. The service layer is on a side of the core layer opposite from the tie layer.

In yet another embodiment, the invention generally relates to multi-layer films comprising a service layer, a core layer, a skin layer, and a tie layer intermediate the core layer and the skin layer, the tie layer having at least 10 wt % of a first polymer having a flexural modulus of not more than 2100 MPa and an elongation of at least 300%. The service layer is on a side of the core layer opposite from the tie layer.

In still another embodiment, the invention generally relates to multi-layer films comprising a service layer, a core layer, and a tie layer, the tie layer having at least 10 wt % of a first polymer, the first polymer having isotactic stereoregularity, and comprising from about 84 wt % to about 93 wt % propylene, from about 7 wt % to about 16 wt % ethylene, and the first polymer having a DSC melting point in the range of from about 42° C. to about 85° C., a heat of fusion less than 75 J/g, crystallinity from about 2% to about 65%, and a molecular weight distribution from about 2.0 to about 3.2.

Some embodiments of the invention generally relate to multi-layer films comprising a service layer, a core layer, and a tie layer, the tie layer having at least 10 wt % of a first polymer made from a polymer blend comprising at least one polymer (A) and at least one polymer (B), polymer (A) comprising from about 60 wt % to about 98 wt % of the blend, and polymer (A) comprising from about 82 wt % to about 93 wt % of units derived from propylene and from about 7 wt % to about 18 wt % of units derived from a comonomer selected from the group consisting of ethylene and an unsaturated monomer other than ethylene, and polymer (A) is further characterized as comprising crystallizable propylene sequences, and polymer (B) comprising an isotactic thermoplastic polymer other than polymer (A).

Additionally, some embodiments of the invention generally relate to multi-layer films comprising a service layer, a core layer and a tie layer, the tie layer having at least 10 wt % of a first polymer made from a polymer blend comprising at least one polymer (A) and at least one polymer (B), polymer (A) comprising from about 60 wt % to about 98 wt % of the blend, and polymer (A) comprising from about 65 wt % to about 96 wt % of units derived from propylene and from about 4 wt % to about 35 wt % of units derived from a comonomer selected from the group consisting of ethylene and an unsaturated monomer other than ethylene, and polymer (A) is further characterized as comprising crystallizable propylene sequences, and polymer (B) comprising an isotactic thermoplastic polymer other than polymer (A).

In another embodiment, the invention generally relates to a method of preparing a sealable multi-layer film, the method comprising the steps of: forming a co-extruded, multi-layer film wherein the film comprises a core layer, a skin layer, and a tie layer intermediate the core layer and the skin layer, the tie layer having at least 10 wt % of a first polymer having a density in the range of 0.850 g/cm³ to 0.900 g/cm³, a DSC melting point in the range of 40° C. to 160° C., and MFR in the range of 2 dg/min. to 100 dg/min; orienting the multi-layer film in at least one direction; and adhering the coextruded multi-layer film with a service layer on a side of the core layer opposite the tie layer.

In some embodiments, the invention generally relates to a multi-layer film comprising a service layer, a core layer, and a tie layer, the tie layer having at least 10 wt % of a first polymer having a density in the range of 0.850 g/cm³ to 0.920 g/cm³, a DSC melting point in the range of 40° C. to 160° C., and a melt flow rate in the range of 2 dg/min. to 100 dg/min., the multi-layer film is formed into a package adapted to contain a product.

In some embodiments, the tie layer first polymer may comprise an impact copolymer or heterophasic polymer blends that typically include an elastomeric compound to incorporate rubber-like properties to the normally rigid backbone or crystal structure of polypropylene-based polymers. In other embodiments, the tie layer first polymer may comprise a random copolymer containing ethylene, propylene, and/or butylene olefin polymers.

Preferably, each of the embodiments also include a service layer on a side of the core layer opposite the tie layer, to improve film functionality, such as processability, handling, barrier, printability, coatability, and other film properties. The service layer may be laminated to the core layer or in some embodiments the service layer may be coated onto or coextruded with the core and tie layers. When the service layer is laminated to the core layer, the lamination may be performed by any acceptable lamination method, such as adhesive lamination using a glue-like adhesive, or by extrusion lamination using a molten polymer as the bonding agent, to bond the service layer with the core layer.

In many preferred embodiments, the films according to this invention may be useful as the inner web in a composite, multi-web laminated product, wherein each web may include a mono-layer or multi-layer polymer-based film. Other suitable web materials for the composite laminated products may include kraft-paper, vacuum deposited metal layer, metal layers such as foil, or other suitable materials as may be useful in the final lamination or extruded composite packaging product.

This invention includes packaging films, methods for making packages and packaging films, and related product applications for the multilayer films of this invention as a hermetically sealable packaging film. Composite packaging film embodiments incorporating the inventive sealable film have been invented and are described and claimed herein. The invention encompasses finished packages, pouches, sealed bags, and other articles embodying the inventive film structures, including but not limited to packaging articles formed using VFFS, HFFS, and pouch machines. Such finished articles may be collectively referred to as “packages.” Packages formed according to the present invention may enjoy the benefits of hermeticity and strong seal strength as provided by primarily polypropylene-based sealing components within the composite film (e.g., the primarily propylene-based tie layer). The invention also includes methods for forming such packaging materials.

### BRIEF DESCRIPTION OF THE DRAWINGS

The drawing is a graph illustrating hermetic area, as determined by the test method described herein.

### DETAILED DESCRIPTION OF THE INVENTION

Various specific embodiments, versions, and examples of the invention will now be described, including exemplary embodiments and definitions that are adopted herein for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to the appended claims, including their equivalents, and elements or limitations that are equivalent to those that are recited. Any reference to the “invention” may refer to one or more, but not necessarily all, of the inventions defined by the claims.

As used herein, “polymer” may be used to refer to homopolymers, copolymers, interpolymers, terpolymers, etc. Likewise, a “copolymer” may refer to a polymer comprising two monomers or to a polymer comprising three or more monomers.

As used herein, “isotactic” is defined as polymeric stereoregularity having at least 40% isotactic pentads of methyl groups derived from propylene according to analysis by ¹³C-NMR.

As used herein, “stereoregular” is defined to mean that the predominant number, e.g., greater than 80%, of the propylene residues in the polypropylene or in the polypropylene continuous phase of a blend, such as impact copolymer exclusive of any other monomer such as ethylene, has the same 1,2 insertion and the stereochemical orientation of the pendant methyl group is the same, either meso or racemic.

As used herein, “intermediate” is defined as the position of one layer of a multi-layer film wherein the layer lies between two other identified layers. In some embodiments, the intermediate layer may be in direct contact with either or both of the two identified layers. In other embodiments, additional layers may also be present between the intermediate layer and either or both of the two identified layers.

As used herein, “elastomer” is defined as a propylene-based or ethylene-based alpha-olefin copolymer, preferably having at least one C₃-C₈ alpha-olefin comonomer, typically having a density of from about 0.86 g/cm³ to about 0.875 g/cm³, a molecular weight of at least 100,000, and that can be extended or stretched with force to at least 100% of it original length, and upon removal of the force, rapidly (e.g., within 5 seconds) returns to its original dimensions.

As used herein, “plastomer” is defined as a propylene-based or preferably ethylene-based, alpha-olefin copolymer, preferably having at least one C₃-C₈ alpha-olefin comonomer, having a density in the range of 0.850 g/cm³ to 0.920 g/cm³, a molecular weight preferably in the range of from about 15000 to about 50,000, and a DSC melting point of at least 40° C. and preferably above 50° C. Plastomers typically include those copolymers having properties generally intermediate those of thermoplastic materials and elastomeric materials. Plastomers typically have higher crystallinity than elastomers, with plastomers typically having crystallinity of at least 10%, and preferably at least 15% to about 25%, as determined by X-ray diffraction.

As used herein, “substantially free” is defined to mean that the referenced film layer is largely, but not wholly, absent a particular component (e.g., the first polymer). In some embodiments, small amounts of the component may be present within the referenced layer as a result of standard manufacturing methods, including recycling of film scraps and edge trim during processing.

As used herein, “first polymer” may be defined to include those homopolymers, copolymers, or polymer blends having at least one of the following sets of properties:
a) Density in the range of 0.850 g/cm³ to 0.920 g/cm³, a DSC melting point in the range of 40° C. to 160° C., and a MFR in the range of 2 dg/min. to 100 dg/min.;
b) A propylene-ethylene copolymer including from about 75 wt % to about 96 wt % propylene, from about 4 wt % to about 25 wt % ethylene and having a density in the range of 0.850 g/cm³ to 0.900 g/cm^{3;}
c) A flexural modulus of not more than about 2100 MPa and an elongation of at least 300%;
d) Isotactic stereoregularity, from about 75 wt % to about 96 wt % propylene, from about 4 wt % to about 25 wt % ethylene, (preferably from about 80 wt % to about 95 wt % propylene and from about 5 wt % to about 20 wt % ethylene; more preferably from about 84 wt % to about 94 wt % propylene and from about 6 wt % to about 16 wt % ethylene; and still more preferably from about 85 wt % to about 92 wt % propylene and from about 8 wt % to about 15 wt % ethylene), a DSC melting point in the range of from about 60° C. to about 148° C., a heat of fusion less than 75 J/g, crystallinity from about 2% to about 65%, and a molecular weight distribution less than or equal to about 3.2 and preferably from about 2.0 to about 3.2;
e) A polymer blend, comprising at least one polymer (A) and at least one polymer (B), polymer (A) comprising from about 60 wt % to about 98 wt % of the blend, and polymer (A) comprising from about 82 wt % to about 93 wt % of units derived from propylene and from about 7 wt % to about 18 wt % of units derived from a comonomer selected from the group consisting of ethylene and an unsaturated monomer other than ethylene, and polymer (A) is further characterized as comprising crystallizable propylene sequences, and polymer (B) comprising an isotactic thermoplastic polymer other than polymer (A); and
f) A polymer blend, comprising at least one polymer (A) and at least one polymer (B), polymer (A) comprising from about 60 wt % to about 98 wt % of the blend, and polymer (A) comprising from about 65 wt % to about 96 wt % of units derived from propylene and from about 4 wt % to about 35 wt % of units derived from a comonomer selected from the group consisting of ethylene and an unsaturated monomer other than ethylene, and polymer (A) is further characterized as comprising crystallizable propylene sequences, and polymer (B) comprising an isotactic thermoplastic polymer other than polymer (A).

We have discovered certain film structures having improved properties. Films according to this invention comprise an arrangement of co-extruded polymeric layers that contribute individually and collectively to improving seal strength, hermeticity (e.g., a seal that does not allow the passage of fluids, including gas, such as air, or liquids, such as water), hot tack, and reduced-temperature sealability of the film.

In the multi-layer films of this invention, a first polymer is incorporated into at least a tie layer to facilitate the improved properties listed above. Preferably, the first polymer is the sole or majority component of the first tie layer. A skin layer may also be provided. The tie layer is a layer that is discrete from the core layer and is positioned on an exterior surface of the core layer, though the tie layer need not be in intimate contact with the core layer. Thereby, other layers may be positioned between the core layer and the tie layer. The tie layer may also comprise a collection of more than one layer that is exterior to the core layer. In some embodiments, a skin layer may also be provided, wherein the tie layer is positioned intermediate the skin layer and the core layer. Similarly, in some embodiments, there may be other layers present between the tie layer and the skin layer.

In some embodiments, the film structures of the present invention have an improved tie layer including a key polymer that may be referred to as a first polymer, and a core layer. In some preferred embodiments, the core layer may incorporate from about 5 wt % to about 45 wt % of the first polymer of the tie layer, and more preferably from about 10 wt % to about 40 wt % of the first polymer, and still more preferably from about 15 wt % to about 35 wt % of the first polymer, based upon the weight of the core layer. In alternative preferred embodiments, the core layer may be substantially free from the first polymer utilized in the tie layer. We have discovered particularly preferred polymers that are suitable for use as the first polymer in the tie layer.

In one preferred embodiment, this invention relates to a multi-layer film, typically a polymeric film having improved sealing properties, such as hermeticity and seal strength, comprising a service layer, a core layer, and a tie layer, the tie layer having at least 10 wt % of a first polymer having a density in the range of 0.850 g/cm³ to 0.920 g/cm³, a DSC melting point in the range of 40° C. to 160° C., and a MFR in the range of 2 dg/min. to 100 dg/min. In some preferred embodiments, the core layer may be substantially free of the first polymer. Preferably, the first polymer is an impact copolymer or a propylene-ethylene copolymer, preferably with a propylene content of at least 75 wt % and ethylene content in the range of 4 wt % to 25 wt %. More preferably, the ethylene content is in the range of 8 wt % to 15 wt %. The service layer is on a side of the core layer opposite from the tie layer.

To provide a reference for discussing the positional relationship among various layers within the multi-layer films discussed herein, it may be helpful to consider each layer of the film as having two sides, with each side on an opposite side of the film. One side may be referred to as a first side while the opposite side is a second side. Thus, each layer may have first and second sides, and similarly, the individual layers or any group of layers, may also be recognized as possessing a first side and a second side on the side opposite from the first side. Thus, the core layer may be considered to have a first side and a second side, and the multilayer film as a whole may also be considered to have first and second sides. For discussion purposes herein, the tie layer is typically positioned on the first side of the core layer, though not necessarily immediately adjacent to the core layer. The side of the multilayer film supporting the first tie layer thereon may be referred to as the first side of the film, with respect to the core layer. Thus, the second side of the core layer and any layers supported on the second side of the core layer represents the second side of the film, with respect to the core layer.

The core layer may be considered to have first and second sides and the tie layer is on the first side of the core layer. Thereby, the tie layer may also be referred to as the “first tie layer.” Some embodiments of the multi-layer film may include an optional tie layer on the opposite or second side of the core layer from the first tie layer, and the tie layer on the second side of the core layer may be referred to as the second tie layer.

Core Layer

The core layer of a multi-layered film is typically the thickest layer and provides the foundation of the multi-layer structure. In some embodiments of this invention, the core layer comprises at least one polymer selected from the group consisting of propylene polymer, ethylene polymer, isotactic polypropylene (iPP), high crystallinity polypropylene (HCPP), ethylene-propylene (EP) copolymers, and combinations thereof. In one preferred embodiment, the core layer comprises an iPP homopolymer. An example of a suitable iPP is ExxonMobil PP4712E1 (commercially available from ExxonMobil Chemical Company of Baytown, Tex.). Another suitable iPP is Total Polypropylene 3371 (commercially available from Total Petrochemicals of Houston, Tex.). An example of HCPP is Total Polypropylene 3270 (commercially available from Total Petrochemicals of Houston, Tex.).

The core layer may also include a key polymer that may be referred to as a first polymer, discussed further, in the “Tie Layer” section below. The first polymer of the tie layer may provide improved resilience, compliance, and conformability to the core layer, which ultimately may facilitate improved seal strength in embodiments having the first polymer in the core layer, as compared to embodiments not having the first polymer in the core layer. The first polymer of the tie layer is discussed in more detail below, under the “Tie Layer” subheading. In some preferred embodiments, the core layer may incorporate from about 5 wt % to about 45 wt % of the first polymer of the tie layer, and more preferably from about 10 wt % to about 40 wt % of the first polymer, and still more preferably from about 15 wt % to about 35 wt % of the first polymer, based upon the weight of the core layer. In alternative preferred embodiments, the core layer may be substantially free from the first polymer utilized in the tie layer.

The core layer may further include a hydrocarbon resin. Hydrocarbon resins may serve to enhance or modify the flexural modulus, improve processability, or improve the barrier properties of the film. The resin may be a low molecular weight hydrocarbon that is compatible with the core polymer. Optionally, the resin may be hydrogenated. The resin may have a number average molecular weight less than 5000, preferably less than 2000, most preferably in the range of from 500 to 1000. The resin can be natural or synthetic and may have a softening point in the range of from 60° C. to 180° C.

Suitable hydrocarbon resins include, but are not limited to petroleum resins, terpene resins, styrene resins, and cyclopentadiene resins. In some embodiments, the hydrocarbon resin is selected from the group consisting of aliphatic hydrocarbon resins, hydrogenated aliphatic hydrocarbon resins, aliphatic/aromatic hydrocarbon resins, hydrogenated aliphatic aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and rosin esters, hydrogenated rosins and rosin esters, and combinations thereof.

Hydrocarbon resins that may be suitable for use as described herein include EMPR 120, 104, 111, 106, 112, 115, EMFR 100 and 100A, ECR-373 and ESCOREZ® 2101, 2203, 2520, 5380, 5600, 5618, 5690 (commercially available from ExxonMobil Chemical Company of Baytown, Tex.); ARKON™ M90, M100, M115 and M135 and SUPER ESTER™ rosin esters (commercially available from Arakawa Chemical Company of Japan); SYLVARES™ phenol modified styrene, methyl styrene resins, styrenated terpene resins, ZONATAC™ terpene-aromatic resins, and terpene phenolic resins (commercially available from Arizona Chemical Company of Jacksonville, Fla.); SYLVATAC™ and SYLVALITE™ rosin esters (commercially available from Arizona Chemical Company of Jacksonville, Fla.); NORSOLENE™ aliphatic aromatic resins (commercially available from Cray Valley of France); DERTOPHENE™ terpene phenolic resins (commercially available from DRT Chemical Company of Landes, France); EASTOTAC™ resins, PICCOTAC™ C₅/C₉ resins, REGALITE™ and REGALREZ™ aromatic and REGALITE™ cycloaliphatic/aromatic resins (commercially available from Eastman Chemical Company of Kingsport, Tenn.); WINGTACK™ ET and EXTRA™ (commercially available from Sartomer of Exton, Pa.); FORAL™, PENTALYN™, and PERMALYN™ rosins and rosin esters (commercially available from Hercules, now Eastman Chemical Company of Kingsport, Tenn.); QUINTONE™ acid modified C₅ resins, C₅/C₉ resins, and acid modified C₅/C₉ resins (commercially available from Nippon Zeon of Japan); and LX™ mixed aromatic/cycloaliphatic resins (commercially available from Neville Chemical Company of Pittsburgh, Pa.); CLEARON™ hydrogenated terpene aromatic resins (commercially available from Yasuhara of Japan); and PICCOLYTE™ (commercially available from Loos & Dilworth, Inc. of Bristol, Pa.). Other suitable hydrocarbon resins may be found in U.S. Pat. No. 5,667,902, incorporated herein by reference. The preceding examples are illustrative only and by no means limiting.

Preferred hydrocarbon resins for use in the films of this invention include saturated alicyclic resins. Such resins, if used, may have a softening point in the range of from 85° C. to 140° C., or preferably in the range of 100° C. to 140° C., as measured by the ring and ball technique. Examples of suitable, commercially available saturated alicyclic resins are ARKON-P® (commercially available from Arakawa Forest Chemical Industries, Ltd., of Japan).

The amount of such hydrocarbon resins, either alone or in combination, in the core layer is preferably less than 20 wt %, more preferably in the range of from 1 wt % to 5 wt %, based on the total weight of the core layer.

The core layer may further comprise one or more additives such as opacifying agents, pigments, colorants, cavitating agents, slip agents, antioxidants, anti-fog agents, anti-static agents, fillers, moisture barrier additives, gas barrier additives, and combinations thereof, as discussed in further detail below. A suitable anti-static agent is ARMOSTAT™ 475 (commercially available from Akzo Nobel of Chicago, Ill.).

For opaque or white film embodiments, cavitating agents may be present in the core layer in an amount less than 30 wt %, preferably less than 20 wt %, most preferably in the range of from 2 wt % to 10 wt %, based on the total weight of the core layer. Alternatively, the core layer may be cavitated by beta nucleation.

Preferably, the total amount of additives in the core layer comprises up to about 20 wt % of the core layer, but some embodiments may comprise additives in the core layer in an amount up to about 30 wt % of the core layer.

The core layer preferably has a thickness in the range of from about 5 μm to 100 μm, more preferably from about 5 μm to 50 μm, most preferably from 5 μm to 25 μm.

Tie Layer

The tie layer is a key layer with respect to the subject inventive film and is positioned intermediate the core layer and an optional skin layer. The tie layer of a multi-layer film is commonly used to connect two layers, such as two layers that might otherwise not bond well due to incompatibility issues. The tie layer may also provide some other functionality, such as barrier enhancement, antiblock particle support, to enhance sealability, machinability, or other benefits, as desired. A primary function of the tie layer in films according to this invention is to provide a tie layer that serves to enhance sealability and seal strength. The tie layer of the inventive film may serve to provide a seal having seal strength properties similar to or better than seal strength properties of traditional sealable films having polyethylene-based outer skin sealant layers.

Another primary function of the polypropylene-based tie layers according to this invention is to provide a seal that is hermetic. Prior art heat sealable films typically required a relatively thick (e.g., 1.5-3 mil (˜30-80 μm)) polyethylene-based outermost skin-type sealant layer to reliably achieve a hermetic seal. Films according to this invention include a tie layer that provides or facilitates a hermetic seal.

In some embodiments, the tie layer is in direct contact with the first surface of the core layer. In other embodiments, another layer or layers may be intermediate the core layer and the functional tie layer described herein.

The tie layer comprises a first polymer, as defined above, and, optionally, one or more other polymers. Preferably, the first polymer comprises C₂C₃ random copolymers, C₂C₃C₄ random terpolymers, impact copolymers, heterophasic random copolymers, C₄ homopolyrners, C₄ copolymers, metallocene polypropylenes, propylene-based or ethylene-based elastomers and/or plastomers, or combinations thereof. In preferred embodiments, the first polymer has a density in the range of 0.850 g/cm³ to 0.920 g/cm³, a DSC melting point in the range of 40° C. to 160° C., and a MFR in the range of 2 dg/min. to 100 dg/min. Preferably, the DSC melting point ranges from 60 ° C. to 148° C., and in some embodiments, the DSC melting point ranges from 80° C. to 135° C. In some preferred embodiments, the first polymer may be a grade of VISTAMAXX™ polymer (commercially available from ExxonMobil Chemical Company of Baytown, Tex.). Exemplary grades of VISTAMAXX™ are VM6100, VM3000, and VM1100. In other preferred embodiments, the first polymer may be a suitable grade of one or more of VERSIFY™ polymer (commercially available from The Dow Chemical Company of Midland, Mich.), Basell CATALLOY™ resins such as ADFLEX™ T100F, SOFTELL™ Q020F, CLYRELL™ SM1340, CLYRELL™ RC1601 (commercially available from Basell Polyolefins of The Netherlands), PB (propylene-butene-1) random copolymers such as Basell PB 8340 (commercially available from Basell Polyolefins of The Netherlands), Borealis BORSOFT™ SD233CF, (commercially available from Borealis of Denmark), EXCEED™ 1012CA and 1018CA metallocene polyethylenes, EXACT™ 5361, 4049, 5371, 8201, 4150, 3132 polyethylene plastomers, EMCC 3022.32 low density polyethylene (LDPE) (commercially available from ExxonMobil Chemical Company of Baytown, Tex.), and JPC XPM 7800 and 7500 C₂C₃C₄ terpolymer (commercially available from Japan Polypropylene Corporation of Japan, (“JPC”) ), or a combination thereof. Other acceptable first polymers comprise a PB copolymer such as Shell SRD4-141 (commercially available from Shell Chemical Company).

In the many preferred embodiments, the first polymer may comprise a propylene-ethylene copolymer and the first tie layer comprises at least 10 wt % of the first polymer in the first tie layer, preferably at least 25 wt % of the first polymer in the first tie layer, more preferably at least 50 wt % of the first polymer in the first tie layer, and most preferably at least 90 wt % of the first polymer in the first tie layer, based upon the weight of the tie layer. In many preferred embodiments, the first tie layer comprises about 100 wt % of the first polymer, based upon the weight of the tie layer.

In some embodiments, the first polymer may have a propylene content ranging from 75 wt % to 96 wt %, preferably ranging from 80 wt % to 95 wt %, more preferably ranging from 84 wt % to 94 wt %, most preferably ranging from 85 wt % to 92 wt %, and an ethylene content ranging from 4 wt % to 25 wt %, preferably ranging from 5 wt % to 20 wt %, more preferably ranging from 6 wt % to 16 wt %, most preferably ranging from 8 wt % to 15 wt %, based upon the weight of the tie layer.

The first polymer preferably has a density ranging from 0.850 g/cm³ to 0.920 g/cm³, more preferably ranging from 0.850 g/cm³ to 0.900 g/cm³, most preferably from 0.870 g/cm³ to 0.885 g/cm³.

The DSC melting point of the first polymer preferably ranges from 40° C. to 160° C. and more preferably from 60° C. to 148° C. Most preferably for some embodiments, the DSC melting point is below 135° C., such as from 60° C. to 135° C.

In some embodiments, the first polymer has a MFR ranging from 2 dg/min. to 100 dg/min., preferably ranging from 2.5 dg/min. to 50 dg/min., more preferably ranging from 2.5 dg/min. to 25 dg/min., most preferably from 2.5 dg/min. to 10 dg/min.

The first polymer may further have a molecular weight distribution (MWD) below 7.0, preferably ranging from 1.8 to 5.0, more preferably ranging from 2.0 to 3.2, most preferably, less than or equal to 3.2.

The first polymer has a flexural modulus of preferably not more than 2100 MPa, more preferably not more than 1500 MPa, still more preferably ranging from 20 MPa to 700 MPa, and most preferably ranging from 50 MPa to 300 MPa.

The elongation of the first polymer may be preferably at least 300%, more preferably at least 400%, even more preferably at least 500%, and most preferably greater than 1000%. In some cases, elongations of 2000% or more are possible.

The latent heat of fusion of the first polymer preferably may be less than 75 J/g, preferably less than 55 J/g, and still more preferably less than 30 J/g.

In some embodiments, the first polymer has isotactic stereoregular crystallinity. In other embodiments, the first polymer has a crystallinity ranging from 2% to 65%.

The first polymer may be produced via a single site catalyst polymerization process. In some embodiments, the single site catalyst incorporates hafnium.

The first tie layer may also comprise one or more additional polymers. When one or more additional polymers are present, the first polymer is preferably present in an amount of from at least about 25 wt % to about 75 wt % of the first tie layer. Amounts of the first polymer of less than 25 wt % (e.g., 10 wt %) or greater than 75 wt % (e.g., 90 wt % or more) are also permissible, depending upon the desired properties for the multi-layer film product. The optional additional polymers may comprise one or more C₂-C₈ homopolymers, copolymers, or terpolymers. Preferably, the additional polymer is comprised of at least one of an iPP homopolymer, an EP copolymer, and combinations thereof. An example of a suitable iPP homopolymer is Total Polypropylene 3371 (commercially available from Total Petrochemicals of Houston, Tex.)

In some embodiments, the first tie layer may further comprise one or more additives such as opacifying agents, pigments, colorants, cavitating agents, slip agents, antioxidants, anti-fog agents, anti-static agents, anti-block agents, fillers, moisture barrier additives, gas barrier additives, and combinations thereof, as discussed in further detail below.

The thickness of the first tie layer is typically in the range of from about 0.50 to 25 μm, preferably from about 0.50 μm to 12 μm, more preferably from about 0.50 μm to 6 μm, and most preferably from about 2.5 μm to 5 μm. However, in some thinner films, the first tie layer thickness may be from about 0.5 μm to 4 μm, or from about 0.5 μm to 2 μm, or from about 0.5 μm to 1.5 μm.

Skin Layer

The multi-layer film also comprises an optional skin layer on the same side of the core layer as the first tie layer, wherein the first tie layer is intermediate the skin and core layers. Many preferred embodiments comprise the skin layer. The skin layer is positioned on the first side of the core layer and typically provides an exterior or outermost surface on the side of the multi-layer film having the tie layer. The skin layer may, however, also support a coating or printing in some alternative embodiments. In the inventive film, the skin layer is usually not as thick as the tie and core layers and is typically a sealable layer. The skin layer of the inventive film is on the sealable side of the film, whereby in some embodiments a fin seal, crimp seal, or pouch seal may result in the skin layer adhering to itself.

In some preferred embodiments of this invention, the skin layer is contiguous to the first tie layer. In other embodiments, one or more other layers may be intermediate the tie layer and the skin layer. As the skin layer is on the first side of the core layer, the skin layer may also be referred to as the first skin layer. The skin layer typically includes a polymer that is suitable for heat-sealing or bonding, when crimped between heated crimp-sealer jaws, fin, or lap sealing jaws. Commonly, suitable skin layer polymers may include copolymers or terpolymers of ethylene, propylene, and butylene and may have DSC melting points either lower than or greater than the DSC melting point of the first polymer. In some preferred embodiments, the first skin layer comprises at least one polymer selected from the group consisting of propylene homopolymer, ethylene-propylene copolymer, butylene homopolymer and copolymer, ethylene-propylene-butylene (EPB) terpolymer, ethylene vinyl acetate (EVA), metallocene-catalyzed propylene homopolymer, and combinations thereof. An example of a suitable EPB terpolymer is JPC 7794 (commercially available from JPC Corporation of Japan).

Heat sealable blends can be utilized in providing the first skin layer. Thus, along with the skin layer polymer identified above there can be, for example, other polymers, such as polypropylene homopolymer, e.g., one that is the same as, or different from, the iPP of the core layer. The first skin layer may additionally or alternatively include materials selected from the group consisting of ethylene-propylene random copolymers, LDPE, linear low density polyethylene (LLDPE), medium density polyethylene (MDPE), and combinations thereof.

The first skin layer may also comprise processing aid additives, such as anti-block agents, anti-static agents, slip agents and combinations thereof, as discussed in further detail below.

The thickness of the first skin layer is typically in the range of from about 0.10 μm to 7.0 μm, preferably about 0.10 μm to 4 μm, and most preferably about 0.10 μm to 3 μm. In some film embodiments, the first skin layer thickness may be from about 0.10 μm to 2 μm, 0.10 μm to 1 μm, or 0.10 μm to 0.50 μm. In some commonly preferred film embodiments, the first skin layer has a thickness in the range of from about 0.5 μm to 2 μm, 0.5 μm to 3 μm, or 1 μm to 3.5 μm.

Service Layer

A service layer is provided on the second side of the core layer, which is the side of the core layer opposite from the tie layer and the optional first side skin layer. The service layer imparts a desired functionality for the final film structure and is preferably incorporated into the composite film structure after formation of the coextruded core and tie layers. One preferred method of incorporation is by laminating the service layer with the core layer to form the composite film structure.

The service layer may improve fitness of the composite film structure for use in a particular application. Though preferably applied to the core layer after coextrusion of the core and tie layers, in some alternative embodiments the service layer could also be coextruded with the core and tie layers. Another layer may be provided in the composite film structure to adhere the service layer with the core layer or to improve adhesion of the service layer with the core layer. The layer that serves to adhere the service and core layers together may be referred to as a bond layer. The bond layer may be essentially any layer that serves to effect adhesion of the service and core layers. When the service layer is laminated to the core layer, the bond layer may be a lamination adhesive or an extruded laminating polymer. When the service layer is coextruded with the core layer and first side tie layer, the bond layer is provided intermediate the service and core layers to bond the service and core layers together, and may be referred to as a second side tie layer.

In many preferred embodiments, however, the core layer is adhered to the service layer after coextrusion of the core layer and first side tie layer. The core and first side tie layer may be coextruded along with a skin layer on a side of the core layer opposite the tie layer, e.g., a second side skin layer, referred to as a second skin layer. Such coextrusion may also include a second side tie layer intermediate the second skin layer and core layer, e.g., a second tie layer. A bond layer may thereafter be used to adhere the service layer to the second skin layer. Further, one or more of the second skin layer and the service layer may be metallized or printed, prior to laminating or otherwise adhering the service layer to the second skin layer.

The service layer may be contiguous to the second side of the core layer or contiguous to one or more other layers positioned intermediate the core layer and the service layer (e.g., a second skin layer). The service layer may comprise merely one layer, such as a second skin layer, or the service layer may comprise multiple layers, such as a paper layer, a metal or foil layer, and/or additional polymer layers, depending upon the desired service or functionality for the composite film.

Some film embodiments may include a service layer, without having the first side skin layer in the film structure, though most preferred embodiments may comprise both a first skin layer and the service layer. The service layer may be provided to improve functionality, such as the film's barrier properties, processability, printability, and/or compatibility for metallization, coating, and/or lamination to other films or substrates. The service layer may be any suitable substrate(s) that provides the desired functional properties and is combinable with the core or other adjoining film layer.

In some embodiments, the service layer comprises a monolayer or a multi-layer polymer film including at least one polymer selected from the group consisting of a PE polymer or copolymer, a PP polymer or copolymer, an ethylene-propylene copolymer, an EPB terpolymer, a PB copolymer, an ethylene-vinyl alcohol (EVOH) polymer, and combinations thereof. In some embodiments, the PE polymer is high-density polyethylene (HDPE), such as HD-6704.67 (commercially available from ExxonMobil Chemical Company of Baytown, Tex.), M-6211, and HDPE M-6030 (commercially available from Equistar Chemical Company of Houston, Tex.). A suitable ethylene-propylene copolymer is Total/Fina 8573 (commercially available from Fina Oil Company of Dallas, Tex.). Preferred EPB terpolymers include Chisso/JPC 7510 and 7794 (commercially available from JPC Corporation of Japan). For coating and printing functions, the service layer may preferably comprise a copolymer that has been surface treated. For metallizing or barrier properties, a HDPE, a PB copolymer, PP or EVOH may be preferred. A suitable EVOH copolymer is EVAL™ G176B (commercially available from Kuraray Company Ltd. of Japan). The service layer may also comprise processing aid additives, such as anti-block agents, anti-static agents, slip agents and combinations thereof, as discussed in further detail below.

The thickness of the service layer or service layer depends upon the intended function of the service layer, but is typically in the range of from about 0.50 μm to 3.5 μm, preferably from about 0.50 μm to 2 μm, and in many embodiments most preferably from about 0.50 μm to 1.5 μm. Also, in thinner film embodiments, the service layer thickness may range from about 0.50 μm to 1.0 μm, or 0.50 μm to 0.75 μm.

In addition to or in lieu of the polymer-film-based service layer(s), the service layer may also comprise other substrates. For example, the service layer may comprise materials such as another polymeric film, foil, printing ink, vapor-deposited metal, a coating material, and/or fiber or paper-based products. The composite film structure may thereby have industrial applicability for a variety of intended purposes, such as high barrier packaging films, high speed films, printed barrier films, package decor, including printing and metallizing, convertability, and other purposes. Such activities and purposes are commonly performed by the ultimate end-users or by converters who process films for supply to the ultimate end-users.

The inventive films may be combined with the service layer such as by lamination, including extrusion lamination and adhesive lamination. Extrusion lamination may include combining the service layer to the side of the core layer opposite the first side tie layer using an extruded or melted polymer between the service layer and the corresponding lamination layer. For example, in one embodiment, an extruded polyethylene, such as HDPE may be used as the lamination bonding material.

Other laminated embodiments of the composite film structure may utilize adhesive lamination, such as by using a glue-like or other adhesive material to combine the service layer with the corresponding lamination layer. When the service layer is combined with the film structure, such as by lamination, a bond layer may be used to bond the service layer to the film structure. In the case of combination by lamination, the bonding layer may be an extruded polymer or an adhesive layer. Exemplary preferred adhesive lamination materials may include a two-part adhesive system, such as Morton Adcote™ 522 adhesive, or Adcote 575S plus catalyst F, which is an ethylene-acetate solvent-based, two-component polyurethane adhesive system, with high chemical and temperature resistance. Other exemplary suitable adhesives may include ethylene acrylic acid copolymers, curable two part urethane adhesives, and epoxy adhesives. As used herein, the term adhesive may also include curable adhesives, heat activated adhesives, and thermoplastics.

In still other embodiments, the service layer may be provided or combined with the core and tie layers by coextrusion with the core and tie layers. As in laminated embodiments, in coextruded embodiments, the service layer is provided on a side of the core layer opposite the first tie layer. Also, in still other laminated or coextruded embodiments, other substrate layers may be provided between the service layer and the core layer. For example, another tie layer may serve as a bonding layer between the service layer and the core layer; or another barrier layer may be provided between the core layer and the service layer.

Second Skin layer

A second skin layer is optional and when present is located intermediate the core layer and the service layer, on a side of the core layer opposite the first side tie layer. Before the service layer is adhered with the core layer, the second skin layer may form an outermost surface of the second side of the core layer. Thereby, the service layer is thereafter adhered with or to the second skin layer.

The second skin layer is typically a layer other than a bond layer, even when a bond layer is also present, but in some embodiments, the second skin layer may function like a bond layer, to improve adhesion of the service layer to the core layer. For example, one preferred embodiment might include (in addition to the core layer and the first side tie layer and optionally a first side skin layer) a second side skin layer on a side of the core layer opposite the first tie layer, and a laminating adhesive bond layer between the second side skin layer and the service layer. The second skin layer may be a treated polymer layer and/or a relatively high energy layer, such as a C₂C₃C₄ terpolymer. Thereby, the resulting composite film structure may comprise a three or four layer film that is laminated to a service layer.

A second side tie layer or second tie layer may also be present between the second skin layer and the core layer. In one embodiment, the second tie layer and/or second skin layer preferably comprises a blend of propylene homopolymer and, optionally, at least one first polymer as included in the first side tie layer, as described above. The propylene homopolymer is preferably an iPP. In some preferred embodiments, the second tie layer and/or second skin layer includes an adhesion promoting material such as ADMER™ AT1179A (commercially available from Mitsui Chemicals America Inc. of Purchase, N.Y.), a maleic anhydride modified polypropylene.

The second tie layer and/or second skin layer may further comprise one or more additives such as opacifying agents, pigments, colorants, cavitating agents, slip agents, antioxidants, anti-fog agents, anti-static agents, anti-block agents, fillers, moisture barrier additives, gas barrier additives, and combinations thereof, as discussed in further detail below.

For many embodiments, the thickness of the second tie layer and/or the second skin layer is preferably in the range of from about 0.5 μm to 25 μm, preferably from about 1 μm to 12 μm, and most preferably from about 1 μm to 10 μm. Also, the thickness may be from about 0.5 μm to 8 μm, or 1 μm to 6 μm, or 1 μm to 4 μm.

Additives

Additives that may be present in one or more layers, as appropriate, of the multi-layer films of this invention, include but are not limited to opacifying agents, pigments, colorants, cavitating agents, slip agents, antioxidants, anti-fog agents, anti-static agents, anti-block agents, fillers, moisture barrier additives, gas barrier additives and combinations thereof. Such additives may be used in effective amounts, which vary depending upon the property required.

Examples of suitable opacifying agents, pigments, or colorants are iron oxide, carbon black, aluminum, titanium dioxide (TiO₂), calcium carbonate (CaCO₃), polybutylene terephthalate (PBT), talc, beta nucleating agents, and combinations thereof.

Cavitating or void-initiating additives may include any suitable organic or inorganic material that is incompatible with the polymer material(s) of the layer(s) to which it is added, at the temperature of biaxial orientation, in order to create an opaque film. Examples of suitable void-initiating particles are PBT, nylon, solid or hollow pre-formed glass spheres, metal beads or spheres, ceramic spheres, calcium carbonate, talc, chalk, or combinations thereof. Cavitation may also be introduced by beta-cavitation, which includes creating beta-form crystals of polypropylene and converting at least some of the beta-crystals to alpha-form polypropylene crystals and creating a small void remaining after the conversion. Preferred beta-cavitated embodiments of the core layer may also comprise a beta-crystalline nucleating agent. Substantially any beta-crystalline nucleating agent (“beta nucleating agent” or “beta nucleator”) may be used. The average diameter of the void-initiating particles typically may be from about 0.1 to 10 μm.

Slip agents may include higher aliphatic acid amides, higher aliphatic acid esters, waxes, silicone oils, and metal soaps. Such slip agents may be used in amounts ranging from 0.1 wt % to 2 wt % based on the total weight of the layer to which it is added. An example of a slip additive that may be useful for this invention is erucamide.

Non-migratory slip agents, used in one or more skin layers of the multi-layer films of this invention, may include polymethyl methacrylate (PMMA). The non-migratory slip agent may have a mean particle size in the range of from about 0.5 μm to 8 μm, or 1 μm to 5 μm, or 2 μm to 4 μm, depending upon layer thickness and desired slip properties. Alternatively, the size of the particles in the non-migratory slip agent, such as PMMA, may be greater than 20% of the thickness of the skin layer containing the slip agent, or greater than 40% of the thickness of the skin layer, or greater than 50% of the thickness of the skin layer. The size of the particles of such non-migratory slip agent may also be at least 10% greater than the thickness of the skin layer, or at least 20% greater than the thickness of the skin layer, or at least 40% greater than the thickness of the skin layer. Generally spherical, particulate non-migratory slip agents are contemplated, including PMMA resins, such as EPOSTAR™ (commercially available from Nippon Shokubai Co., Ltd. of Japan). Other commercial sources of suitable materials are also known to exist. Non-migratory means that these particulates do not generally change location throughout the layers of the film in the manner of the migratory slip agents. A conventional polydialkylsiloxane, such as silicone oil or gum additive having a viscosity of 10,000 to 2,000,000 centistokes is also contemplated. Other embodiments may comprise a silicone-based slip additive, such as a silicone gum having a viscosity of from about 15,000,000 centistokes to about 30,000,000 centistokes.

Suitable anti-oxidants may include phenolic anti-oxidants, such as IRGANOX™ 1010 (commercially available from Ciba-Geigy Company of Switzerland). Such an anti-oxidant is generally used in amounts ranging from 0.1 wt % to 2 wt %, based on the total weight of the layer(s) to which it is added.

Anti-static agents may include alkali metal sulfonates, polyether-modified polydiorganosiloxanes, polyalkylphenylsiloxanes, and tertiary amines. Such anti-static agents may be used in amounts ranging from about 0.05 wt % to 3 wt %, based upon the total weight of the layer(s).

Examples of suitable anti-blocking agents may include silica-based products such as SYLOBLOC™ 44 (commercially available from Grace Davison Products of Colombia, Md.), PMMA particles such as EPOSTAR™ (commercially available from Nippon Shokubai Co., Ltd. of Japan), or polysiloxanes such as TOSPEARL™ (commercially available from GE Bayer Silicones of Wilton, Conn.). Such an anti-blocking agent comprises an effective amount up to about 3000 ppm of the weight of the layer(s) to which it is added.

Fillers useful in this invention may include finely divided inorganic solid materials such as silica, fumed silica, diatomaceous earth, calcium carbonate, calcium silicate, aluminum silicate, kaolin, talc, bentonite, clay and pulp.

Suitable moisture and gas barrier additives may include effective amounts of low-molecular weight resins, hydrocarbon resins, particularly petroleum resins, styrene resins, cyclopentadiene resins, and terpene resins.

Optionally, one or more skin layers may be compounded with a wax or coated with a wax-containing coating, for lubricity, in amounts ranging from 2 wt % to 15 wt % based on the total weight of the skin layer. Any conventional wax, such as, but not limited to Carnauba™ wax (commercially available from Michelman Corporation of Cincinnati, Ohio) that is useful in thermoplastic films is contemplated.

Film Orientation

The embodiments of this invention include possible uniaxial or biaxial orientation of the multi-layer films. Orientation in the direction of extrusion is known as machine direction (MD) orientation. Orientation perpendicular to the direction of extrusion is known as transverse direction (TD) orientation. Orientation may be accomplished by stretching or pulling a film first in the MD followed by TD orientation. Blown films or cast films may also be oriented by a tenter-frame orientation subsequent to the film extrusion process, again in one or both directions. Orientation may be sequential or simultaneous, depending upon the desired film features. Preferred orientation ratios are commonly from between about three to about six in the machine direction and between about four to about ten in the transverse direction. Typical commercial orientation processes are BOPP tenter process, blown film, and LISIM technology.

Surface Treatment

One or both of the outermost or exterior surfaces of the multi-layer films of this invention may be surface-treated to increase the surface energy to render the film receptive to metallization, coatings, printing inks, and/or lamination. The surface treatment can be carried out according to one of the methods known in the art including corona discharge, flame, plasma, chemical treatment, or treatment by means of a polarized flame. For composite film embodiments including laminations of layers, one or more of the surfaces to be laminated may also be surface treated.

Metallization

One or both of the outer surfaces of the multi-layer films of this invention may be metallized. Such layers may be metallized using conventional methods, such as vacuum metallization by deposition of a metal layer such as aluminum, copper, silver, chromium, or mixtures thereof.

Coating

In some embodiments, one or more coatings, such as for barrier, printing and/or processing, may be applied to one or both of the outer surfaces of the multi-layer films of this invention. Such coatings may include acrylic polymers, such as ethylene acrylic acid (EAA), ethylene methyl acrylate copolymers (EMA), polyvinylidene chloride (PVdC), poly(vinyl)alcohol (PVOH) and EVOH. The coatings are preferably applied by an emulsion coating technique, but may also be applied by co-extrusion and/or lamination.

The PVdC coatings that are suitable for use with the multi-layer films of this invention are any of the known PVdC compositions heretofore employed as coatings in film manufacturing operations, e.g., any of the PVdC materials described in U.S. Pat. No. 4,214,039, U.S. Pat. No. 4,447,494, U.S. Pat. No. 4,961,992, U.S. Pat. No. 5,019,447, and U.S. Pat. No. 5,057,177, incorporated herein by reference.

Known vinyl alcohol-based coatings, such as PVOH and EVOH, that are suitable for use with the multi-layer films invention include VINOL™ 125 or VINOL™ 325 (both commercially available from Air Products, Inc. of Allentown, Pa.). Other PVOH coatings are described in U.S. Pat. No. 5,230,963, incorporated herein by reference.

Before applying the coating composition to the appropriate substrate, the outer surface of the film may be treated as noted herein to increase its surface energy. This treatment can be accomplished by employing known techniques, such as flame treatment, plasma, corona discharge, and film chlorination, e.g., exposure of the film surface to gaseous chlorine, treatment with oxidizing agents such as chromic acid, hot air or steam treatment, flame treatment and the like. Although any of these techniques is effectively employed to pre-treat the film surface, a frequently preferred method is corona discharge, an electronic treatment method that includes exposing the film surface to a high voltage corona discharge while passing the film between a pair of spaced electrodes. After treatment of the film surface, the coating composition is then applied thereto.

An intermediate primer coating may be applied to multi-layer films of this invention. In this case, the film may be first treated by one of the foregoing methods to provide increased active adhesive sites thereon and to the thus-treated film surface there may be subsequently applied a continuous coating of a primer material. Such primer materials are well known in the art and include, for example, epoxy and poly(ethylene imine) (PEI) materials. U.S. Pat. No. 3,753,769, U.S. Pat. No. 4,058,645 and U.S. Pat. No. 4,439,493, each incorporated herein by reference, disclose the use and application of such primers. The primer provides an overall adhesively active surface for thorough and secure bonding with the subsequently applied coating composition and can be applied to the film by conventional solution coating means, for example, by roller application.

The coating composition can be applied to the film as a solution, one prepared with an organic solvent such as an alcohol, ketone, ester, and the like. However, since the coating composition can contain insoluble, finely divided inorganic materials that may be difficult to keep well dispersed in organic solvents, it is preferable that the coating composition be applied to the treated surface in any convenient manner, such as by gravure coating, roll coating, dipping, spraying, and the like. The excess aqueous solution can be removed by squeeze rolls, doctor knives, and the like.

The film can be stretched in the MD, coated with the coating composition and then stretched perpendicular in the TD. In yet another embodiment, the coating can be carried out after biaxial orientation is completed.

The coating composition may be applied in such an amount that there will be deposited upon drying a smooth, evenly distributed layer. The coating may be dried by hot air, radiant heat, or by any other convenient means. Coatings useful in this invention may have coating weights ranging from 0.5 g/m² to 1.6 g/m² for conventional PVOH coatings, 0.78 g/m2 to 2.33 g/m² for conventional acrylic and low temperature seal coatings (LTSC) and 1.6 g/m² to 6.2 g/m² for conventional PVdC coatings.

### INDUSTRIAL APPLICABILITY

Multi-layer films according to the present invention are useful as substantially stand-alone film webs or they may be coated, metallized, and/or laminated to other film structures. Multi-layer films according to the present invention may be prepared by any suitable methods comprising the steps of co-extruding a multi-layer film according to the description and claims of this specification, orienting and preparing the film for intended use such as by coating, printing, slitting, or other converting methods. Preferred methods comprise co-extruding, then casting and orienting the multi-layer film, as discussed in this specification.

In one aspect, a method of preparing or forming a multi-layer film according to the present invention comprises the steps of co-extruding at least:
a core layer having a first side and a second side;
a tie layer, the tie layer containing at least 10 wt % of a first polymer having a density in the range of 0.850 g/cm³ to 0.920 g/cm³, a DSC melting point in the range of 40° C. to 160° C., and MFR in the range of 2 dg/min. to 100 dg/min.; and
an optional skin layer;
the tie layer being intermediate the core layer and the optional skin layer and the tie layer being on the first side of the core layer.

The method may further comprise the step of orienting the co-extruded, multi-layer film in at least one direction.

The method described above includes the step of providing a service layer with the core layer, either at the time of co-extruding the core and tie layers such as by co-extrusion, or more typically after production of the core and tie layers, such as by lamination. The service layer is positioned on the second side of the core layer, which is the side of the core layer opposite the tie layer. The method may include the step of forming the multi-layer film and thereafter combining the service layer to the core layer, such as by using a bond layer. The bond layer may include substantially any material that may bond or combine the service layer to the core layer, such as a lamination adhesive, including adhesive lamination or extrusion lamination. The service layer may also comprise one more of a polymer film; a coating; a paper, such as kraft-paper; a metal layer; and ink, such as printing ink. The formed multilayer film may include a structural film composition that incorporates any of the core layer and tie layer embodiments of this invention. In some preferred embodiments, the tie layer first polymer comprises from about 75 wt % to about 96 wt % propylene, from about 4 wt % to about 25 wt % ethylene, and the first polymer has a density in the range of from about 0.850 g/cm³ to about 0.900 g/cm³. In other embodiments, the first polymer comprises from about 80 wt % to about 95 wt % propylene and from about 5 wt % to about 20 wt % ethylene, and the first polymer has a DSC melting point in the range of 40° C. to 160° C., more preferably in the range of 60° C. to 148° C., still more preferably in the range of 80° C. to 140° C., and comprise a molecular weight distribution in the range of 2.0 to 3.2.

The method of preparing the sealable multi-layer film may further comprise the step of surface treating the multi-layer film on the side of the core layer opposite the tie layer to increase the surface energy thereof. Thereby, a stronger lamination bond may be obtained for some embodiments. In other aspects, the method may also include the step of metallizing the multi-layer film on the treated, second side of the core layer.

One advantage of applying the service layer to the core layer by lamination is that printing ink, a coating, or a metal layer may be applied to the second side of the core layer and/or the adjoining side of the service layer. Subsequent to printing, treating, coating, and/or metallizing, the service layer may be combined with the core layer, such that the printing, coating, and/or metal layer is buried within the lamination and protected by the service layer and core layer.

The inventive films according to this invention may have particular applicability as a flexible packaging film and more particularly as a sealable flexible packaging film. In a preferred application, the films may be useful as a hermetically sealable packaging film. A film may be considered hermetically sealable when it prevents the leakage or migration of a liquid, particularly a gaseous liquid, such as air, through the sealed area of a heat-formed seal. A seal may be formed by applying pressure and heat at the intended seal area, optionally for a determined duration of time and at a determined temperature and pressure, to cause the overlapped portions of the film to adhesively and hermetically engage with each other to create a fin seal, a lap seal, a pouch seal, and/or a crimp seal, in the seal area. During formation of the seal, the engaged layers may become fused so that the interface between the sealed layers effectively disappears and the engaged layer interface become effectively impervious to transmission through the interface of fluids, such as a gas, over a range of temperature and pressure conditions as the intended packaging application may experience. For example, a package containing snack-food may be sealed at an elevation near sea level, in a relatively cool environment, and later transported over a mountain range in the back of a hot truck trailer, or on an airplane. The gas within the package may thereby expand greatly, increasing the pressure within the bag and increasing the temperature of the polymer holding the seal closed. A seal formed according to this invention should withstand such rigorous application, without leaking or losing hermeticity and seal strength integrity. The term hermetic seal may refer to both peelable and unpeelable seals that do not permit the passage of fluid. To form a hermetic seal, the volume or area at the seal interface, between the sealed surfaces, must be completely filled during sealing, with the polymer material.

The subject inventive films and methods permit creation of a package that includes a polypropylene-based tie layer, e.g., the seal layer, without relying upon a polyethylene-based tie/sealant layer to maintain a hermetic seal over a wide range of foreseeable operating or application conditions. This invention includes a package that is produced from or includes the sealable, multi-layer films of this invention. A package may be defined broadly as a container in which a product (e.g., a food product) may be at least partially contained by at least a portion of the subject film, wherein the package is at least partially formed using the subject inventive film, that is at least partially heat sealed, and also including the product therein contained. Thereby, the package may be formed substantially wholly from the subject inventive film or the film may be combined with other packaging materials to form a complete package. The package may be heat sealed on all seals or may be partially heat sealed and further closed or secured by means in addition to heat sealing, including but not limited to adhesive sealing, stapling, folding, crimping, twisting, and/or securing with separate tie-materials, such as wire twists. Although the inventive film herein is capable of forming a hermetic seal, the invention also includes packages formed using the inventive film that may not be completely hermetically sealed, due for example, to contaminates in the seal area, the nature of the total enclosure, or the conditions used to close or secure the package.

In one embodiment, a package according to this invention may comprise a hermetically sealable polymer film containing:
a) a core layer;
b) a tie layer, the tie layer having at least 10 wt % of a first polymer having a density in the range of 0.850 g/cm³ to 0.920 g/cm³, a DSC melting point in the range of 40° C. to 160° C., and a melt flow rate in the range of 2 dg/min. to 100 dg/min.; and
c) a service layer on a side of the core layer opposite the core layer;

wherein the multi-layer film is formed into a package adapted to contain a product.

The package may preferably also comprise a bond layer between the core layer and the service layer. In one embodiment, the package is a pouch. The multi-layer film may optionally comprise a skin layer on the first side of the core layer, wherein the first tie layer is intermediate the core layer and the skin layer. Preferably, a crimp seal of a side of the multi-layer film including the tie layer to the same side of the multi-layer film including the tie layer (e.g., a fin seal or crimp seal) has a seal strength of at least about 700 g/cm for a seal formed on a VFFS crimp sealer, with some embodiments exceeding 1000 g/cm, and still other embodiments have seal strengths of at least about 1180 g/cm, as demonstrated in the Examples below. In other aspects, a crimp seal of a side of the multi-layer film including the tie layer to the same side of the multi-layer film including the tie layer (e.g., a fin seal or a crimp seal) has seal strength of at least about 500 g/cm for a seal formed on a VFFS crimp sealer.

Many preferred embodiments of the subject film or resulting package are substantially clear or transparent embodiments, except of course for printing, metallization, or combining with other substrates. However, the inventive film may also include opaque or white embodiments that include a cavitated core layer. In some embodiments, the core layer comprises a cavitating agent. In cavitated embodiments, a crimp seal of a side of the multi-layer film including the tie layer to the same side of the multi-layer film including the tie layer (e.g., a fin seal or a crimp seal) has a seal strength of at least about 512 g/cm for a seal formed on a VFFS crimp sealer.

In other embodiments or applications, the package may comprise a seal formed by a lap seal, wherein a lap seal of a side of the multi-layer film including the tie layer to a side of the multi-layer film including the service layer has a seal strength of at least about 220 g/cm in the lap seal for the lap seal formed on a VFFS lap sealer. In still other embodiments, a seal of the skin layer to itself, such as in a fin seal has seal strength of at least about 350 g/cm for a fin seal formed on a HFFS sealer, with some embodiments having an HFFS fin seal strength of up to and at least 1040 g/cm. It may be common to provide HFFS formed seals having seal strengths of at least 1000 g/cm, when formed for example at 86 feet per minute on a Fuji Alpha V, and at least 846 g/cm when formed at 250 feet per minute on that same machine. It will be demonstrated in the examples below that comparative terpolymer seal layer films are not even sealable on such equipment at 250 feet per minute.

With regard to the inventive film, a pouch, side seal of the skin layer to itself demonstrates seal strength of at least about 930 g/cm for a side seal formed on a pouch machine. In other embodiments, the side seal of the skin layer to itself demonstrate seal strength of up to and exceeding 1100 g/cm, with some embodiments tested in excess of 1180 g/cm for a side seal of a pouch formed on a pouch machine.

The method of forming a package may comprise the steps of enclosing a product or article within at least a portion of the co-extruded film, engaging a first portion of the first side of the film with a second portion of the first side of the film, such as a pouch, fin, or crimp seal, and applying pressure and heat at the engaged seal area, optionally for a determined duration of time and optionally at a determined temperature and pressure, to cause the two engaged portions to bond, forming a hermetic seal. The method may further comprise additionally co-extruding a second tie layer and a service layer on the multi-layer film.

The prepared multi-layer film may be used as a flexible packaging film to package an article or good, such as a food item or other product. In some applications, the film may be formed into a pouch type of package, such as may be useful for packaging a product, such as beverage, liquid, granular, or dry-powder or other packagable product.

### EXPERIMENTAL

The multi-layer film of the present invention will be further described with reference to the following non-limiting examples.

Testing Methods

Density is measured according to ASTM D-1505 test method.

The procedure for Differential Scanning Calorimetry (DSC) is described as follows. From about 6 mg to about 10 mg of a sheet of the polymer pressed at approximately 200° C. to 230° C. is removed with a punch die. This is annealed at room temperature for at least 2 weeks. At the end of this period, the sample is placed in a Differential Scanning Calorimeter (TA Instruments Model 2920 DSC) and cooled to about −50° C. to about −70° C. The sample is heated at 20° C./min to attain a final temperature of about 200° C. to about 220° C. The thermal output is recorded as the area under the melting peak of the sample which is typically peaked at about 30° C. to about 175° C. and occurs between the temperatures of about 0° C. and about 200° C. is a measure of the heat of fusion expressed in Joules per gram of polymer. The melting point is recorded as the temperature of the greatest heat absorption within the range of melting of the sample.

Melt Flow Rate (MFR) is measured according to ASTM D-1238, 2.16 kg. at 230° C. with a 1 minute preheat on the sample to provide a steady temperature for the duration of the experiment.

Techniques for determining the molecular weight distribution (MWD) may be found in U.S. Pat. No. 4,540,753, incorporated herein by reference, and references cited therein and in Macromolecules, 1988, volume 21, p 3360, which is incorporated herein by reference, and references cited therein.

Flexural modulus is measured according to ASTM D-790 test method.

Elongation at break is measured according to ASTM D-638 test method.

Heat of Fusion is measured according to ASTM E 794-85 test method.

Percent crystallinity was derived from the thermal output measurement of the DSC procedure described above. The thermal output for the highest order of polypropylene is estimated at 189 J/g (i.e., 100% crystallinity is equal to 189 J/g).

Seal strength may be determined using sealing devices such as a LAKO™ Heat Sealer (Model SL-10), HAYSSEN™ Heat Sealer (Model Ultima II), and a FUJI™ Heat Sealer (Model Alpha V). Also, the seal strength of flexible barrier materials may be determined according to the standard testing method of ASTM F 88-00.

Minimum seal temperature (MST) is determined as follows: heat seals are formed using one of the above heat sealers at temperatures that are raised incrementally. The minimum seal temperature is reached when one temperature yields a seal value of less than a specified g/cm. peel force and the next temperature yields a seal value of greater than or equal to the specified g/cm. peel force. The specified peel force of the LAKO™ Heat Sealer, HAYSSEN Heat Sealer and the FUJI™ Heat Sealer is 80 g/cm.

A LAKO™ Heat Sealer (Model SL-10), (commercially available from Lako Tool & Manufacturing, Inc. of Perrysburg, Ohio), may be used to form a seal and evaluate its seal strength. The LAKO™ Heat Sealer is an automated film testing device that is capable for forming a film seal, determining the seal strength, and generating a seal profile from film samples. The operating range is from ambient to 199° C., sealing pressure of 0.04 MPa to 2.69 MPa, and a dwell time of 0.2 seconds to 20 seconds.

The seal strength of a seal formed using the HAYSSEN™ Ultima II vertical form, fill and seal (VFFS) machine (commercially available from Hayssen Packaging Technologies of Duncan, S.C.), may be determined as follows: a film or lamination is placed on the machine. The crimp temperature is set at or above the MST of the film or lamination. The lap and/or fin seal temperature is set above the MST of the film or lamination. A total of six to nine empty bags measuring approximately 35.6 cm by 13.3 cm are produced at the rate 55 bags/min. Two bags are randomly selected and seal strengths are measured on a Suter tester. Preferred seal strength range is greater than 80 g/cm. The crimp temperature is increased in increments of approximately 5.5° C. and the test is repeated according to the steps above until the film or lamination is visually, thermally distorted. The seal range is reported as upper crimp distortion temperature minus the crimp MST. The method described above is repeated to determine the seal strength of the lap and/or fin seal.

The seal strength of a seal formed using a FUJI™ Heat Sealer (Alpha V) machine (commercially available from Fuji Packaging Co. Ltd. of Japan), may be determined as follows: a roll of film or lamination is placed on the machine. The crimp temperature is set at or above the MST of the film or lamination. The lap and/or fin seal temperature is set above the MST of the film or lamination. A total of twenty empty bags measuring approximately 35.6 cm by 13.3 cm are produced at the rate 150 bags/min. Two bags are randomly selected and seal strengths are measured on a Suter tester. Preferred seal strength range is greater than 80 g/cm.

Hot tack performance may be determined using devices such as a HAYSSEN™ Ultima II VFFS machine (commercially available from Hayssen Packaging Technologies of Duncan, S.C.), as follows: a roll of film or lamination is placed on the VFFS machine. The crimp temperature is set at or above the MST of the film or lamination. The lap and/or fin seal temperature is set above the MST of the film or lamination. A total of six to nine empty bags measuring approximately 35.6 cm by 13.3 cm are produced at the rate 55 bags/min. Three bags are randomly selected and filled with approximately 454 grams of large, dense, particulate product. The bags are then examined for seal creep (e.g., loosening or release of seal width). Preferred seal creep is less than 0.16 cm for all crimp seals and lap and/or fin seals on the bag. The crimp temperature is increased in increments of approximately 5.5° C. and the test is repeated according to the steps above until the film or lamination is visually, thermally distorted. Seal and hot tack range is reported as upper seal distortion temperature minus the seal MST.

Hermetic area may be determined using devices such as a HAYSSEN™ Ultima II VFFS machine (commercially available from Hayssen Packaging Technologies of Duncan, S.C.), at the speed of 55 bags/min. Empty bags measuring approximately 35.6 cm by 13.3 cm filled with air are sealed at specified temperatures for lap and/or fin seal at the back of the bag and crimp seal on both ends of the bag. Twenty bags are put under water at 20.3 cm Hg vacuum for 60 seconds. If no bubbles are observed from all 20 of the submersed bags, the seal is considered a hermetic seal under the test conditions. If even one of the twenty bags bubbles, the seal is not hermetic and the test condition fails as not hermetic. The temperature settings are modified incrementally and the test is repeated until the hermetic area is determined. As illustrated in the drawing, test results are recorded on a graph with tested crimp seal temperatures on the x-axis in increasing increments of 5.5° C. and lap and/or fin seal temperatures on the y-axis in increasing increments of 5.5° C. The graph is proportionally divided into contiguous, non-overlapping boxes. As shown by the shaded area 10 of the drawing, each test resulting in a hermetic seal is represented by one shaded box on the graph corresponding to the lap and/or fin seal and crimp seal temperature settings. The final hermetic area is determined by calculating the total of all filled boxes on the graph. For example, in the drawing, the hermetic area is 47 boxes. The hermetic area of the multi-layer films of this invention range from about 23 boxes to greater than 67 boxes, indicating successful, efficient hermetic seal performance in packaging applications. By comparison, in one prior art application example, about 16 boxes might be considered as a minimum acceptable hermetic performance range. The exemplified range of the inventive film is truly outstanding performance.

### EXAMPLES

### Comparative Example 1

The multi-layer film of Comparative Example 1 was melt coextruded, quenched on a casting drum, and subsequently reheated in the machine direction orienter (MDO) to about 85° C. to 105° C. The film was then stretched in the MD at 4.3 times and further annealed in the annealing sections of the machine direction orienter.

The MD stretched base sheet was subjected to further TD orientation via conventional tenter frame at nine times in the TD. The typical transverse direction preheat temperature is about 155° C. to 180° C., stretching temperature is about 145° C. to 165° C., and standard annealing temperature is about 165° C. to 170° C.

The second skin (or coextruded service layer) was further treated by a conventional flame treatment method and then wound in a mill roll form. The overall thickness of the finished film is about 31.25μ. The film had a four layer structure, as follows:

| | | Thickness |
|---|---|---|
| | Polymer | (μm) |
| First skin layer | JPC 7794 - C₂C₃C₄ terpolymer | 2 |
| Tie layer (Comparative) | Total 3371 - PP homopolymer | 5 |
| Core layer | Total 3371 - PP homopolymer | 23.7 |
| Second skin layer | JPC 7510 - C₂C₃C₄ terpolymer | 0.6 |
| (Coextruded Service layer) | | |

The film sample in Comparative Example 1 was further tested for seal range, seal strength and hot tack strength by:
1. Lab LAKO™ sealer
2. VFFS packaging machine
3. HFFS packaging machine
   Results are provided in Table 1, below.

### Example 2

Comparative Example 1 was repeated, except the tie layer was changed from a Ziegler-Natta isotactic PP to a VM3000 propylene-ethylene copolymer.

The film had a four layer structure, as follows:

| | | Thickness |
|---|---|---|
| | Polymer | (μm) |
| First skin layer | JPC 7794 - C₂C₃C₄ terpolymer | 2 |
| Tie/sealant layer | EMCC VM3000 - propylene- | 5 |
| (Exemplary) | ethylene copolymer | |
| Core layer | Total 3371 - PP homopolymer | 23.7 |
| Second skin layer | JPC 7510 - C₂C₃C₄ terpolymer | 0.6 |
| (Coextruded Service Layer) | | |

### Example 3 to 9

Example 2 was repeated, but the tie layer polymers, all of which are “first polymers” as defined herein, were as follows:

| Example | Tie layer resin (Each Exemplary) |
|---|---|
| 3 | Borsoft SD233CF - heterophasic random copolymer |
| 4 | VM6100 - propylene-ethylene copolymer |
| 5 | EMCC 3002.32 LLDPE - hexene copolymer |
| 6 | Exact 4049 - ethylene-butene copolymer |
| 7 | Basell Adflex T100F - heterophasic random copolymer |
| 8 | VM 3000 − propylene-ethylene copolymer + 50% |
| | Total 3371 − PP homopolymer |
| 9 | VM 3000 − propylene-ethylene copolymer + 75% |
| | Total 3371 − PP homopolymer |

The films samples from Examples 1 through 9 were tested for seal range, seal strength and hot tack as described herein. A summary is provided in Table 1, below.

TABLE 1

| | | | Hayssen | Hayssen | Fuji | Fuji |
|---|---|---|---|---|---|---|
| | | Lako | VFFS | VFFS | HFFS fin | HFFS |
| | Lako | ultimate | crimp | ultimate | seal and | ultimate fin |
| | crimp seal | crimp seal | seal and | crimp seal | hot tack | seal |
| | and hot | strength | hot tack | strength | seal range | strength |
| Example | tack MST (C.) | (g/cm) | range (C.) | (g/cm) | (C.) | (g/cm) |
| 1 | 90 | 393 | 38 | 678 | 10 | 596 |
| 2 | 74 | 1,120 | 54 | >1,200* | 27 | >1,200* |
| 3 | 86 | 1,089 | 43 | >1,200* | 27 | >1,200* |
| 4 | 77 | 1,003 | 54 | 1,078 | 27 | >1,200* |
| 5 | 83 | 694 | 49 | 1,022 | 27 | >1,200* |
| 6 | 72 | 750 | 60 | 1,004 | 38 | 1,000 |
| 7 | 83 | 1,073 | 49 | 1,096 | 21 | 904 |
| 8 | 84 | 1,122 | 49 | >1,200* | 21 | >1,200* |
| 9 | 79 | 1,218 | 54 | >1,200* | 21 | >1,200* |

*> means seal strengths exceeded the measuring capability of the test equipment.

Example 2 through Example 9 demonstrate improvements resulting from this invention when compared to control Example 1 including:

Broadening the VFFS seal range by 5° C. to 22° C. This improvement is significant and is about 20% to 40% of a very good terpolymer heat sealing resin.

Broadening the HFFS seal range by 11° C. to 28° C. As in VFFS, the improvement in HFFS is extraordinary and significant. One sample doubled the seal range and the improvement was 40% to 100%. This is truly outstanding.

Delivering outstanding ultimate seal strength. By LAKO™ test, ultimate seal strength was improved by 1.8 to 2.5 times. By VFFS and HFFS, ultimate seals in this invention were >1,200 g/cm which were off scale based on the lab Suter tester unit. Empty bags from Sample 2 tested 2,036 g/cm on an Instron® machine. Many of the >1,200 g/cm samples have potentially very high seal strength.

Maintaining excellent hot tack throughout the seal range as shown by VFFS test method. Seal range is defined by acceptable hot tack and seal strength is greater than 80 g/cm. Both seal strength and hot tack were tested using ExxonMobil Chemical Company test methods defined above.

### Comparative Example 10

Comparative Example 1 was repeated in an 18μ structure with the following layer thicknesses and configuration:

| | | Thickness |
|---|---|---|
| | Polymer | (μm) |
| First skin layer | JPC 7794 - C₂C₃C₄ terpolymer | 2 |
| Tie layer (Comparative) | Total 3371 - PP homopolymer | 5 |
| Core layer | Total 3371 - PP homopolymer | 10.4 |
| Second skin layer (Not a | JPC 7510 - C₂C₃C₄ terpolymer | 0.6 |
| service Layer) | | |

The film sample in Comparative Example 10 was further tested for seal range, seal strength, hot tack strength and hermeticity by:
1. Lab LAKO™ sealer on plain film
2. VFFS packaging machine on laminations
3. HFFS packaging machine on laminations
4. Hermeticity on laminations

A three-layer laminated composite film structure was prepared as follows: 70 SLP (service layer)/10# Chevron 1017 (extruded polymeric laminating adhesive bond layer)/Comparative Example 10. 70 SLP is an ExxonMobil Chemical Company commercial product and is typically considered not heat sealable. This product was selected to allow fin seal testing of the laminated product. The 70 SLP is the service layer in this embodiment, as it becomes the outermost layer on the side of the core layer opposite the (first) tie layer, after the final laminated composite film structure is prepared.

### Example 11

Comparative Example 10 was repeated, including the extrusion lamination to a different service layer, except the tie layer was changed from a comparative Ziegler-Natta isotactic PP to an exemplary VM3000 propylene-ethylene copolymer.

The exemplary film had a four layer structure, as follows:

| | | Thickness |
|---|---|---|
| | Polymer | (μm) |
| First skin layer | JPC 7794 - C₂C₃C₄ terpolymer | 2 |
| Tie/Sealant layer | EMCC VM3000 - propylene-ethylene | 5 |
| (Exemplary) | copolymer | |
| Core layer | Total 3371 - PP homopolymer | 10.4 |
| Second skin layer (Not | JPC 7510 - C₂C₃C₄ terpolymer | 0.6 |
| the service layer) | | |

### Example 12 to 18

Example 11 was repeated, but the (first) tie layer polymers were as follows:

| Example | Tie layer resin |
|---|---|
| 12 | Borsoft SD233CF - heterophasic random copolymer |
| 13 | VM6100 - propylene-ethylene copolymer |
| 14 | EMCC 3002.32 LLDPE - hexene copolymer |
| 15 | Exceed 1012 CA - VLDPE hexene copolymer |
| 16 | Basell Adflex T100F - heterophasic random copolymer |
| 17 | JPP 7500 - C₂C₃C₄ terpolymer |
| 18 | Basell PB 8340 - PB random copolymer |

The three-layer laminated structure of Examples 11 though 18 was prepared as follows: 70 LCX (service layer)/10# Chevron 1017 (lamination adhesive bond layer)/Exemplary Examples 11-18. Service layer 70 LCX is an ExxonMobil Chemical Company commercial product and is heat-sealable on only one side. This product was selected to allow lap seal hermeticity testing of the laminated product.

The films samples from Examples 10 through 18 were tested, and a summary is in Table 2, below.

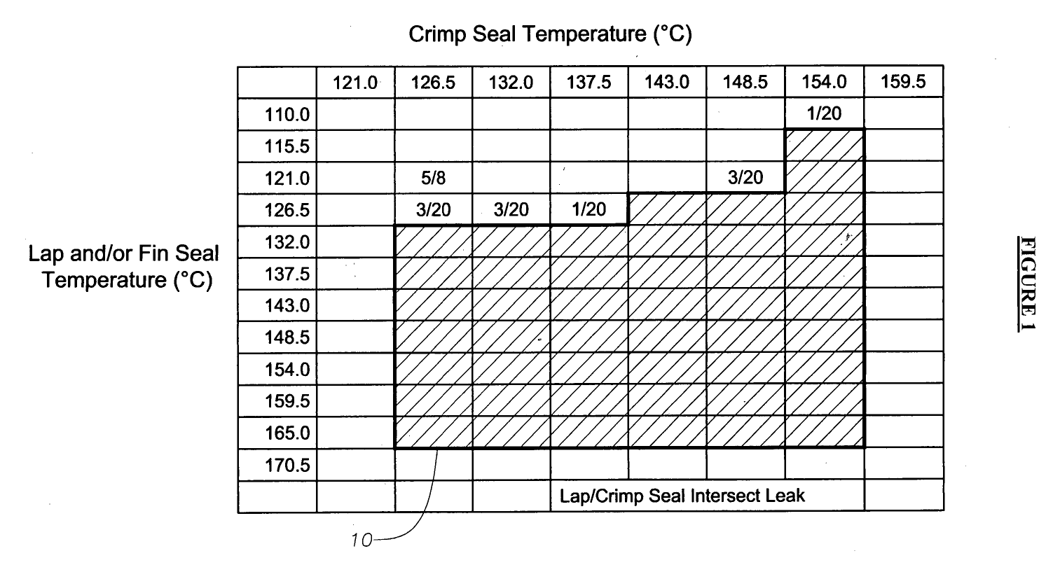

TABLE 2

| | | | Hayssen | Hayssen | Fuji | Fuji | |
|---|---|---|---|---|---|---|---|
| | | | VFFS | VFFS | HFFS | HFFS | |
| | | Lako | crimp | ultimate | crimp | ultimate | |
| | | ultimate | seal and | crimp seal | seal | crimp seal | Hermeticity |
| | Lako | seal | hot tack | strength | range | strength | (# boxes) |
| Example | MST (C.) | (g/cm) | range (C.) | (g/cm) | (C.) | (g/cm) | See FIG. 1 |
| 10 | 91 | 325 | 38 | 442 | 38 | 314 | 0 |
| | | | | | | | (not |
| | | | | | | | hermetic) |
| 11 | 72 | 636 | 54 | 1,104 | 49 | 1062 | 48 |
| 12 | ** | ** | ** | 1,104 | ** | ** | 23 |
| 13 | 77 | 816 | 54 | 1,078 | 54 | >1,200* | 23 |
| 14 | 82 | 551 | 49 | 476 | 43 | 632 | 46 |
| 15 | 80 | 673 | 49 | 744 | 43 | 824 | 50 |
| 16 | 83 | 578 | 43 | 792 | 38 | 982 | 46 |
| 17 | 77 | 642 | 49 | 854 | 54 | 814 | 28 |
| 18 | 87 | 751 | 43 | 1,004 | 38 | >1,200* | >67* |

*> exceeded the measuring capability of the test equipment.
** Not tested

As demonstrated above and illustrated in FIG. 1, in addition to the improvements shown in Examples 2 to 9, the 18 μm structures in this invention have dramatically improved seal strengths, seal ranges, and hermeticity characteristics versus Comparative Example 10.

Referring to Table 3 through Table 6, additional film structures were prepared, whereby the inventive film structures were combined with various service layer(s) and bond layer(s) to form laminated composite film structures that may be suitable for use in various applications. The combined service layers are described below, but are generally commercially available multi-layer films, including 70 LCX, 50 HM, and BSR-ONE, (each available from ExxonMobil Chemical Company), and kraft paper. In the following examples, the service layers are combined with the inventive film via extrusion or adhesive lamination, as indicated in the tables below.

Tests were preformed for each of VFFS, HFFS, and pouch applications. Each exemplified application below provides; (i) one or more comparative test results according to prior art composite film structures; and (ii) one or more exemplary test results, according to the film compositions, methods, and packages of this invention. Comparative tests are denoted in the tables below as “comparative,” while the exemplary tests according to this invention are denoted as “exemplary.” Comparative films included various commercial films that are available from ExxonMobil Chemical Company, including 70 Met-HB, 110 MU842, 28 UBW-ES, polyethylene, and BSR-ONE, each of which include either a polypropylene tie (sealant) layer or an ethylene-propylene-butylene terpolymer tie (sealant) layer. The laminations were provided by both extrusion lamination and adhesive lamination, as indicated in the tables below. The extrusion laminated samples were laminated by bond layer melt extrusion of 10# polyethylene (PE). 14# of PE is known in the industry as producing a lamination layer thickness of about 1.0 mil or 25μm. Thus, a 10# PE lamination layer thickness results in a bond layer thickness of about 0.7 mil or about 70 gauge units. In the crimp tests, the crimp jaws typically include a horizontal pattern. The tables below define the machine operating speed in terms of PPM, (packs per minute).

The inventive film structure (provided as the inner web of the lamination) included a four layer structure comprising, for example, an 80 gauge embodiment having a 50 gauge polypropylene core, a 3 gauge polyethylene-based high energy second skin layer, an 8 gauge ethylene-propylene-butylene terpolymer first side skin layer, with the first side tie layer of 100 wt % of a polymer according to this invention, for example, 20 gauge Adflex T100F, based upon the weight of the tie layer. If desired, the outer surface of the second skin layer may be metallized to improve barrier properties. Testing of the various film embodiments demonstrates that the inventive film sealant technology is superior to prior art best-in-class sealable OPP films. The data also suggests that the improved hermetic nature and high seal strengths of the inventive film may provide functionality suitable for replacing polyethylene tie-sealant layers and terpolymer skin sealant layers of prior art multi-layer sealable OPP films. The results below demonstrate the improvements:

### VFF&S Example

TABLE 3
Hayssen Ultima II VFF&S at 55 PPM: Lap Seal

| | | Crimp | | | |
|---|---|---|---|---|---|
| | | Seal | | | |
| | Crimp Seal | Hot Tack | Lap Seal | Hermetic | Maximum |
| | Hot Tack | Range: | Strength | Operating | Crimp Seal |
| | MST: ° F. | ° F. | g/in | Window: | Strength: g/in |
| Structure | ° C. | ° C. | g/cm | # of Boxes | g/cm |
| Clear | | | | | |
| 19) 70 LCX/10# PE/70 Met- | 200 | 110 | 550 | 0 | 1215 |
| HB (Comparative) | 93 | 66 | 216 | | 478 |
| 20) 70 LCX/10# PE/80 ga | 190 | 120 | 580 | 61 | 3000+ |
| (20μ) inventive film with tie | 88 | 66 | 228 | | 1180+ |
| layer of Example 16 | | | | | |
| (Exemplary) | | | | | |
| Cavitated | | | | | |
| 21) 70 LCX/10# PE/110 | 210 | 100 | 580 | 0 | 980 |
| MU842 (Comparative) | 99 | 55 | 228 | | 386 |
| 22) 70 LCX/10# PE/28 | 190 | 120 | 540 | 0 | 1300 |
| UBW-ES (Comparative) | 88 | 66 | 213 | | 512 |
| 23) 70 LCX/10# PE/110 ga | 180 | 130 | 560 | 51 | 1300 |
| (28μ) inventive film with tie | 82 | 72 | 220 | | 512 |
| layer of Example 16 | | | | | |
| (Exemplary) | | | | | |

The test results displayed in Table 3 demonstrate that in both clear and cavitated embodiments, film embodiments including the inventive film in the product lamination provide improved crimp seal strength, lap seal strength, and hermetic sealing performance. Crimp seal strengths of at least about 1000 g/cm are demonstrated in clear embodiments, with the data supporting crimp seal strengths in excess of 1180 g/cm, for a crimp seal formed on a VFFS crimp sealer. This compares to 478 g/cm for the prior art 70 Met-HB structure that utilizes a terpolymer tie sealant layer. Further improvements were noted in the hermeticity testing, where the inventive structure demonstrated a hermetic operating window containing 61 graphic boxes, while the comparative prior art film did not demonstrate hermeticity under the same production and testing conditions. Also, hot tack MST was also reduced by 10° C. for the inventive film. Lap seal performance also exhibited improved hermeticity and reduced hot tack MST.

Improvements were also noted in the cavitated films. The prior art MU842 and UBW embodiments lacked hermeticity, while the inventive films demonstrated a hermetic operating range of 51 graphic boxes, such as exemplified in FIG. 1. The seal strengths were at least as strong as the strongest known prior art embodiment. Hot tack MST improvement was also noted.

The hermetic performance of the exemplary embodiments of the sealant technology was further validated on a Woodman™ Polaris commercial packaging machine, at 55 PPM. (Data not provided.) The tested inventive structure was 70 LCX/10#PE/80 ga (20μ) inventive film, with the Adflex tie layer. The Woodman™ was operated to form lap seals. The hermetic sealing, operating window that was demonstrated on the Woodman™ machine with lap seals was nearly identical to the results obtained on the Hayssen™ with lap seals. During another commercial packaging machine trial, hermetic seals also were produced when the same structure was run on a TNA™ wrapper, at 88 PPM, with a lap seal, though with a slightly reduced hermetic operating window size.

3 and 4 Side Seal Pouch

Testing was also conducted for 3 side seal and 4 side seal pouches. Outside webs in the laminated structure included paper, polyethylene terephthalate (PET) and OPP. Seal strength for both top seals and side seals, hermetic performance, and burst strengths are key metrics. The inventive sealant technology clearly exceeds best-in-class prior art OPP sealants and is highly competitive and fit for use to replace the prior art polyethylene sealant tie layers in many packaging film applications.

TABLE 4
Klockner Bartelt ™ @ 72 PPM, Pouch Seals

| | Top Seal | Side Seal | | |
|---|---|---|---|---|
| | Strength @ | Strength @ | Mocon | |
| | 300° F./150° C.: | 300° F./150° C.: | Burst | |
| | g/in | g/in | Strength: | Hermetic |
| Structure | g/cm | g/cm | PSI | Seals? |
| 24) Paper service | 530 | 650 | *<1.6 | Yes |
| layer/adhesive/70 Met-HB | 209 | 256 | | |
| (Comparative) | | | | |
| 25) Paper service | 1340 | 1600 | >4.5 | Yes |
| layer/PE/Alternative Inventive | 528 | 630 | | |
| Film, with 10μ thick tie layer | | | | |
| (Exemplary) | | | | |
| 26) Paper service | 3000+ | 2730 | >4.7 | Yes |
| layer/PE/Inventive film, with | 1181+ | 1075 | | |
| 18μ thick tie layer as Example | | | | |
| 16 (Exemplary) | | | | |
| 27) 50 HM service layer/ | 3000+ | 3000+ | >6.4 | Yes |
| PE/Inventive film, with 18μ | 1181+ | 1180+ | | |
| thick tie layer as Example 16 | | | | |
| (Exemplary) | | | | |
| 28) Paper service | 2200 | 2360 | >6.0 | Yes |
| layer/PE/Foil/PE tie layer, as | 866 | 930 | | |
| Example 16 (Comparative) | | | | |

*Not directly measured in this experiment but other experiments using crimp seals, fin seals, and pouch seals of a prior art sealable OPP film structure, such as ExxonMobil's 70-Met-HB, sealed to itself, are known to have typical burst strength ratings of less than 1.6 psig. This table demonstrates the significant improvements in burst strength performance provided by the inventive sealable film structures.

The data of Table 4 was generated with flat, non-gusseted pouches. Though not tested, it is expected that qualitatively similar results will result from production of gusseted pouches. The paper service layer in the above examples is 28# bleached white Kraft Paper. In one embodiment the paper is laminated with a glue-type adhesive, while in the other four examples the paper is extrusion laminated. The laminating adhesive is a glue-type adhesive, identified as Morton Adcote™ 522, typically at 0.1 mil or 2.5μ thickness.

The pouch data demonstrates improved side seal strength and top seal strength. Side seal strengths were measured in excess of the 930 g/cm demonstrated for the prior art best-in-class structure. Side seal strengths of at least 1075 g/cm were measured, with one embodiment demonstrating at least 1180 g/cm.

HFF&S

For HFF&S applications the sealing capabilities of the inventive technology were explored on a Fuji™ Alpha V packaging machine. This testing included determination of seal range and seal strengths, and is presented at 86 ft/minute in Table 5, and at 250 ft/min in Table 6.

TABLE 5
Fuji ™ Alpha V @ 86′/minute, Fin Seals

| | Max Seal | Seal |
|---|---|---|
| | Strength: | Range: |
| | g/in | ° F. |
| Structure | g/cm | ° C. |
| 125 ga (32μ) BSR-ONE (Comparative) | 845 | 60 |
| | 333 | 33 |
| 125 ga (32μ) of inventive film with tie | 2640 | 100 |
| layer of Example 16 (Exemplary) | 1040 | 56 |

TABLE 6
Fuji ™ Alpha V @ 250′/minute, Fin Seals

| | Max Seal | Seal |
|---|---|---|
| | Strength: | Range: |
| | g/in | ° F. |
| Structure | g/cm | ° C. |
| 125 ga (32μ) BSR-ONE | N/A | 0 (did not |
| (comparative) | | seal) |
| 125 ga (32μ) of inventive film with tie | 2150 | 40 |
| layer of Example 16 | 846 | 23 |

Achieving package hermeticity with OPP films using a polypropylene-based sealant layer is demonstrated by the present invention. Additionally, this invention demonstrates polyethylene-like sealant layer seal strengths with a polypropylene-based sealant layer. Over the past few decades, the film industry has made some advances in reducing sealant initiation temperatures, seal ranges, and modestly increasing seal strengths. However, the improvements demonstrated by this invention, such as achieving fully hermetic seal performance, and polyethylene-like seal strengths and package burst performance, easily exceed the performance of the prior art films and are truly revolutionary.

The present invention is described herein with reference to embodiments of multi-layer films, including a tie layer containing polymer blends comprising a first polymer; however, various other film structures are contemplated. Those skilled in the art will appreciate that numerous modifications to these embodiments may be made without departing from the scope of our invention. For example, while certain film layers are exemplified as being comprised of specific polymer blends and additives, along with certain arrangement of layers within the film, other compositions, and arrangements are also contemplated. Additionally, while packaging is discussed as among the uses for embodiments of our inventive films, other uses, such as labeling and printing, are also contemplated.

To the extent that this description is specific, it is solely for the purpose of illustrating certain embodiments of the invention and should not be taken as limiting the present inventive concepts to these specific embodiments. Therefore, the spirit and scope of the appended claims should not be limited to the description of the embodiments contained herein.

What is claimed is:

1. A sealable, multi-layer film comprising:
a) a core layer;
b) a tie layer, the tie layer having at least 10 wt % of a first polymer having a density in the range of 0.850 g/cm³ to 0.920 g/cm³, a DSC melting point in the range of 40° C. to 160° C., and a melt flow rate in the range of 2 dg/min to 100 dg/min; and
c) a service layer on a side of the core layer opposite the tie layer.

2. The film of claim 1, wherein the tie layer first polymer comprises at least one of an impact copolymer, random copolymer, random terpolymer, random PB copolymer, heterophasic random copolymer, and a Catalloy™ resin.

3. The film of claim 1, wherein the tie layer comprises at least about 90 wt % of the first polymer.

5. The film of claim 1, further comprising:
a bond layer between the core layer and the service layer.

6. The film of claim 1, further comprising:
a skin layer, the tie layer being intermediate the core layer and the skin layer.

7. The film of claim 1, wherein the tie layer comprises at least 25 wt % of the first polymer.

8. The film of claim 1, wherein the first polymer has a density in the range of 0.850 g/cm³ to 0.900 g/cm³.

9. The film of claim 1, wherein the first polymer has a DSC melting point in the range of 60° C. to 148° C.

10. The film of claim 1, further comprising:
a second skin layer on a side of the core layer opposite the tie layer.

11. The film of claim 1, wherein the tie layer further comprises one or more other C₂-C₈ homopolymers, copolymers or terpolymers.

12. The film of claim 1, wherein the core layer comprises at least one polymer selected from the group consisting of propylene, ethylene, isotactic polypropylene, ethylene-propylene copolymers, and combinations thereof.

13. The film of claim 1, wherein the core layer further comprises at least one additive selected from the group consisting of opacifying agents, void-initiating particles, hydrocarbon resins, fillers, anti-static agents, and combinations thereof.

14. The film of claim 6, wherein the skin layer comprises at least one polymer selected from the group consisting of propylene homopolymer, ethylene-propylene copolymer, butylene homopolymer and copolymer, ethylene-propylene-butylene terpolymer, ethyl vinyl acetate, metallocene-catalyzed propylene homopolymer, and combinations thereof.

15. The film of claim 6, wherein the skin layer further comprises at least one polymer selected from the group consisting of ethylene-propylene random copolymers, low density polyethylene, linear low density polyethylene, medium density polyethylene, and combinations thereof.

16. The film of claim 6, wherein at least one of the core layer, the tie layer and the skin layer further comprises at least one additive selected from the group consisting of opacifying agents, cavitating agents, fillers, anti-blocks, anti-static agents, coefficient of friction modifiers, processing aids, colorants, and combinations thereof.

17. The film of claim 1, wherein a crimp seal of a side of the multi-layer film including the tie layer to the side of the multi-layer film including the tie layer has seal strength of at least about 1000 g/cm for a crimp seal formed on a VFFS crimp sealer.

18. The film of claim 6, wherein a crimp seal of a side of the multi-layer film including the tie layer to the side of the multi-layer film including the tie layer has seal strength of at least about 700 g/cm for a crimp seal formed on a VFFS crimp sealer.

19. The film of claim 1, wherein the core layer comprises a cavitating agent and wherein a crimp seal of a side of the multi-layer film including the tie layer to the side of the multi-layer film including the tie layer has seal strength of at least about 500 g/cm for a crimp seal formed on a VFFS crimp sealer.

20. The film of claim 1, wherein a lap seal of a side of the multi-layer film including the tie layer to a side of the multi-layer film including the service layer has seal strength of at least about 220 g/cm for a lap seal formed on a VFFS lap sealer.

21. The film of claim 6, wherein a seal of the skin layer to itself has seal strength greater than 333 g/cm for a fin seal formed on a HFFS sealer.

22. The film of claim 6, wherein a seal of the skin layer to itself has seal strength of at least about 846 g/cm for a fin seal formed on a HFFS sealer.

23. The film of claim 6, wherein a pouch side seal of the skin layer to itself has a seal strength grater than about 866 g/cm for a side seal formed on a pouch machine.

24. The film of claim 6, wherein a side seal of the skin layer to itself has a seal strength greater than about 1000 g/cm for a side seal of a pouch formed on a pouch machine.

25. The film of claim 1, wherein the tie layer first polymer further comprises:
from about 75 wt % to about 96 wt % propylene and from about 4 wt % to about 25 wt % ethylene.

26. The film of claim 1, wherein the tie layer first polymer further comprises:
from about 80 wt % to about 95 wt % propylene and from about 5 wt % to about 20 wt % ethylene, and the first polymer has a DSC melting point in the range of 60° C. to 148° C., and a molecular weight distribution in the range of 2.0 to 3.2.

27. The film of claim 1, wherein the first polymer comprises from about 84 wt % to about 94 wt % propylene and from about 6 wt % to about 16 wt % ethylene.

28. The film of claim 1, wherein the first polymer comprises from about 85 wt % to about 92 wt % propylene and from about 8 wt % to about 15 wt % ethylene.

29. The film of claim 1, wherein the core layer substantially comprises isotactic polypropylene.

30. The film of claim 1, wherein a seal of a side of the multi-layer film including the tie layer to the side of the multi-layer film including the tie layer has burst strength of at 1.6 psig, wherein such seal is at least one of a crimp seal, a fin seal, and a pouch seal.

31. The film of claim 1, wherein the first polymer has a flexural modulus of not more than 2100 MPa and an elongation of at least 300%.

32. The film of claim 1, wherein the core layer comprises from about 5 wt % to about 45 wt % of the first polymer, based upon the weight of the core layer.

33. The film of claim 1, wherein the core layer comprises from about 10 wt % to about 40 wt % of the first polymer, based upon the weight of the core layer.

34. The film of claim 1, wherein the core layer is substantially free of the first polymer.

35. The film of claim 1, wherein the service layer comprises at least one of a polymer film, a coating, a paper layer, a metal layer, ink, and combinations thereof.

36. The film of claim 5, wherein the bond layer comprises at least one of a glue-based adhesive, a pressure sensitive adhesive, a laminating adhesive, an extruded adhesive, and a polymer film.

37. The film of claim 36, wherein the bond layer comprises a coating comprising at least one of an ethylene acrylic acid, an ethylene vinyl alcohol, a polylactic acid, a polyvinyl alcohol, and a polyvinyl chloride.

38. The film of claim 36, wherein the extruded adhesive comprises polyethylene.

39. A method of preparing a sealable multi-layer film comprising the steps of:
a) forming a multi-layer film, wherein the film comprises,
i) a core layer, the core layer having a first side and a second side;
ii) a tie layer, the tie layer having at least 10 wt % of a first polymer having a density in the range of 0.850 g/cm³ to 0.920 g/cm³, a DSC melting point in the range of 40° C. to 160° C., and melt flow rate in the range of 2 dg/min to 100 dg/min;
iii) an optional skin layer; and
iv) the tie layer being intermediate the core layer and the optional skin layer and the tie layer on the first side of the core layer;
b) orienting the co-extruded, multi-layer film in at least one direction; and
c) providing a service layer on the multi-layer film of step a) on a side of the core layer opposite the tie layer.

40. The method of claim 39, wherein the first polymer comprises from about 75 wt % to about 96 wt % propylene, from about 4 wt % to about 25 wt % ethylene, and the first polymer has a density in the range of from about 0.850 g/cm³ to about 0.900 g/cm³.

41. The method of claim 39, wherein the first polymer comprises from about 80 wt % to about 95 wt % propylene and from about 5 wt % to about 20 wt % ethylene, and the first polymer has a DSC melting point in the range of 40° C. to 160° C. and a molecular weight distribution in the range of 2.0 to 3.2.

43. The method of claim 39, further comprising the step of:
bonding the service layer to the multi-layer film using a bond layer.

44. The method of claim 43, wherein the step of bonding comprises the step of laminating the service layer to the multi-layer film by extrusion lamination.

45. The method of claim 43, wherein the step of bonding comprises laminating the service layer to the multi-layer film by adhesive lamination.

46. The method of claim 39, further comprising the step of:
surface treating the multi-layer film formed in step a) on a side of the core layer opposite the tie layer to increase the surface energy thereof.

47. The method of claim 39, further comprising the step of:
metallizing the multi-layer film formed in step a) on a side of the core layer opposite the tie layer to increase the surface energy thereof.

48. The method of claim 39, further comprising the step of:
printing the multi-layer film formed in step a) on a side of the core layer opposite the tie layer.

49. The method of claim 39, further comprising the step of:
printing at least one side of the service layer with a printing ink.

50. The method of claim 39, further comprising the step of:
coating the multi-layer film formed in step a) on a side of the core layer opposite the tie layer.

51. The method of claim 39, wherein the service layer comprises a polymeric film and the polymeric film includes a sealable layer on a side of the service layer opposite the core layer.

52. The method of claim 39, wherein the service layer comprises at least one of a polymer film, a coating, a paper layer, a metal layer, and ink.

53. A package comprising a sealable film, the sealable multilayer film comprising:
a) a core layer;
b) a tie layer, the tie layer having at least 10 wt % of a first polymer having a density in the range of 0.850 g/cm³ to 0.920 g/cm³, a DSC melting point in the range of 40° C. to 160° C., and a melt flow rate in the range of 2 dg/min. to 100 dg/min.; and
c) a service layer on a side of the core layer opposite the tie layer;
wherein the sealable film is formed into a package adapted to contain a product.

54. The package of claim 53, wherein the multi-layer film further comprises a skin layer, the tie layer being intermediate the core layer and the skin layer.

55. The package of claim 53, wherein a seal of the side of the film including the tie layer to the side of the film including the tie layer forms a hermetic seal.

56. The package of claim 53, further comprising at least one of:
a bond layer and a second skin layer positioned between the core layer and the service layer.

57. The package of claim 53, wherein a crimp seal of a side of the multi-layer film including the tie layer to the side of the multi-layer film including the tie layer has seal strength of at least about 1000 g/cm for a seal formed on a VFFS crimp sealer.

58. The package of claim 53, wherein a crimp seal of a side of the multi-layer film including the tie layer to the side of the multi-layer film including the tie layer has seal strength of at least about 700 g/cm for a seal formed on a VFFS crimp sealer.

59. The package of claim 53, wherein the core layer comprises a cavitating agent and wherein a crimp seal of a side of the multi-layer film including the tie layer to the side of the multi-layer film including the tie layer has a seal strength of at least about 512 g/cm for a seal formed on a VFFS crimp sealer.

60. The package of claim 53, wherein a lap seal of a side of the multi-layer film including the tie layer to a side of the multi-layer film including the service layer has seal strength of at least about 220 g/cm for a lap seal formed on a VFFS lap sealer.

61. The package of claim 53, wherein a seal of the side of the multi-layer film including the tie layer to the side of the multilayer film including the tie layer has seal strength of at least about 350 g/cm for a fin seal formed on a HFFS sealer.

62. The package of claim 53, wherein a seal of the side of the multi-layer film including the tie layer to the side of the multilayer film including the tie layer has seal strength of at least about 1000 g/cm for a fin seal formed on a HFFS sealer.

63. The package of claim 53, wherein a seal of the side of the multi-layer film including the tie layer to the side of the multilayer film including the tie layer has seal strength of at least about 846 g/cm for a fin seal formed on a HFFS sealer.

64. The package of claim 53, wherein a pouch side seal of the side of the multi-layer film including the tie layer to the side of the multilayer film including the tie layer has seal strength of at least about 1100 g/cm for a side seal formed on a pouch machine.

65. The package of claim 53, wherein a side seal of the side of the multi-layer film including the tie layer to the side of the multilayer film including the tie layer has seal strength of at least about 930 g/cm for a side seal of a pouch formed on a pouch machine.

66. The package of claim 53, wherein a top seal of the side of the multi-layer film including the tie layer to the side of the multilayer film including the tie layer has seal strength of at least about 870 g/cm for a top seal of a pouch.

67. The package of claim 53, wherein a seal of a side of the multi-layer film including the tie layer to the-side of the multi-layer film including the tie layer has burst strength of at lease 1.6 psig.

68. A method of forming a package comprising the steps of:
a) feeding a multi-layer film into a packaging machine, wherein the film has a first side and a second side, is oriented in at least one direction, and comprises;
i) a core layer having a first side and a second side;
ii) a tie layer on a first side of the core layer and on the first side of the film with respect to the core layer, the tie layer having at least 10 wt % of a first polymer having a density in the range of 0.850 g/cm³ to 0.920 g/cm³, a DSC melting point in the range of 40° C. to 160° C., and melt flow rate in the range of 2 dg/min to 100 dg/min;
iii) a skin layer on the first side of the core layer, the tie layer being intermediate the core layer and the skin layer; and
iv) a service layer on the second side of the core layer and on a second side of the film with respect to the core layer;
b) crimping the first side of the film to at least one of the first side of the film and the second side of the film to form a seal.

69. The method of claim 68, wherein the step of crimping comprises the step of:
crimping the first side of the film to the first side of the film, using a VFFS crimp sealer, to form a seal having a seal strength of at least about 1000 g/cm.

70. The method of claim 68, wherein the core layer comprises a cavitating agent and the step of crimping comprises the step of:
crimping the first side of the film to the first side of the film, using a VFFS crimp sealer, to form a crimp seal having a seal strength of at least about 700 g/cm.

71. The method of claim 68, wherein the step of crimping comprises the step of:
crimping the first side of the film to the second side of the film, using a VFFS lap sealer to form a lap seal having a seal strength of at least about 220 g/cm.

72. The method of claim 68, wherein the step of crimping comprises the step of:
crimping the first side of the film to the first side of the film, using an HFFS sealer to form a fin seal having a seal strength of at least about 350 g/cm.

73. The method of claim 68, wherein the step of crimping comprises the step of:
crimping the first side of the film to the first side of the film using an HFFS sealer to form a fin seal having a seal strength of at least about 1000 g/cm.

74. The method of claim 68, wherein the step of crimping comprises the step of:
crimping the first side of the film to the first side of the film on a pouch machine to form a pouch seal having a seal strength of at least about 930 g/cm.

75. The method of claim 68, wherein the tie layer first polymer further comprises:
from about 75 wt % to about 96 wt % propylene and from about 4 wt % to about 25 wt % ethylene.

76. The method of claim 68, further comprising the step of:
bonding the service layer on the second side of the film to form a laminated film, using at least one of a glue adhesive and an extruded polymer adhesive.

77. The method of claim 68, further comprising the step of:
printing the multi-layer film the second side of the core layer with a printing ink.

78. The method of claim 68, further comprising the step of:
printing on at least one side of the service layer and the second side of the core layer with a printing ink.

79. The method of claim 68, wherein a seal of the side of the film including the tie layer to the side of the film including the tie layer forms a hermetic seal.
